(19) United States
(12) Patent Application Publication
(10) Pub. No.: US 2021/0297252 A1
(43) Pub. Date: Sep. 23, 2021

(54) RAPID CRYPTOGRAPHY METHODS AND DEVICES FOR SECURE DATA ACCESS

(71) Applicant: Princeton Biocode Inc., Princeton, NJ (US)

(72) Inventors: D.C. Licciardello, Princeton, NJ (US); Robert H. Austin, Princeton, NJ (US); Johannes Dapprich, Lawrenceville, NJ (US); Paul Lewis, Asbury, NJ (US); Glenn Paul, Titusville, NJ (US)

(73) Assignee: Princeton Biocode Inc., Princeton, NJ (US)

(21) Appl. No.: 17/205,292

(22) Filed: Mar. 18, 2021

Related U.S. Application Data
(60) Provisional application No. 63/100,561, filed on Mar. 18, 2020.
(60) Provisional application No. 63/102,477, filed on Jun. 16, 2020.

(51) Int. Cl. H04L 9/30; H04L 9/08; G06K 19/06

(52) U.S. Cl. CPC H04L 9/3066; H04L 2209/16; G06K 19/06037; H04L 9/0866

(57) ABSTRACT

The invention relates to rapid cryptography methods and devices for secure data access. A private key is temporarily created for a cryptography use on a computer for decrypting a document. A device comprising a second data matrix, which is external to the computer, is read by the computer, which processes the second data matrix using a first data matrix already present on the computer. Then, the first data matrix provides the means for stepping through the second data matrix to create a private key. Next, the private key is erased immediately after the private key is created and used in a cryptography process for accessing secure data. The first and second data matrices are hidden by the user, and the private key is not stored, but instead is temporarily re-created as needed only for rapidly accessing secure data.

### CROSS-REFERENCE TO RELATED APPLICATIONS SECTION

This Application is a United States Non-Provisional Patent Application that claims priority to U.S. Provisional Patent Application Ser. No. 63/100,561 filed on Mar. 18, 2020 and U.S. Provisional Patent Application Ser. No. 63/102,477 filed on Jun. 16, 2020, the entirety of which are hereby incorporated by reference in their entirety.

### FIELD OF THE EMBODIMENTS

The field of the invention generally relates to rapid cryptography methods and devices for secure data access. In general, a private key is temporarily created for a cryptography use on a computer for decrypting a document. A device comprising a first data matrix, which is external to the computer, is read by the computer, which processes the first data matrix using a second data matrix already present on the computer. Then, the second data matrix provides the means for stepping through the first data matrix to create a private key. Next, the private key is erased immediately after the private key is created and used in a cryptography process for accessing secure data. The first and second data matrices are hidden by the user, and the private key is not stored, but instead is temporarily re-created as needed only for rapidly accessing secure data.

### BACKGROUND OF THE EMBODIMENTS

Typically, computer users who need to protect a confidential document use a password or a private key. User passwords can be stolen and a user of a blockchain must never lose control of their private key. A blockchain is a shared database that records transactions between two parties in an immutable ledger. Blockchains confirm pseudonymous ownership of all existing coins within a cryptocurrency ecosystem at any given time through cryptography. After a transaction is validated and cryptographically verified by other participants or nodes in the network, it is made into a “block” on the blockchain. A block contains information about the time the transaction occurred, previous transactions, and details about the transaction. Once recorded as a block, transactions are ordered chronologically and cannot be altered. This technology rose to popularity after the creation of bitcoin, the first application of blockchain technology, which has since catalyzed other cryptocurrencies and applications.

Due to its nature of decentralization, blockchain use is potentially a serious problem in that blockchain transactions and data are not verified and owned by one single entity as they are in typical systems. Rather, the validity of transactions are confirmed by any node or computer that has access to the network. Blockchain technology secures and authenticates transactions and data through cryptography. However, with the rise and widespread adoption of technology, data breaches have become frequent.

User information and data are often stored, mishandled, and misused, causing a threat to personal privacy. Currently, many entities desire a widespread adoption of blockchain technology for its ability to increase user privacy, data protection, and data ownership. However, blockchain-related technologies are complex and difficult to learn. The global nature of the blockchain ecosystem adds a further layer of complexity.

Crime has been expanding beyond national borders for years, but blockchain takes this globalization to another level. Parties conduct transactions and transfers between continents in a matter of minutes, and the digital infrastructure of the blockchain itself almost always transcends territorial boundaries. Adding to that difficulty are the facts that some of the largest crypto-asset exchanges operate outside of the United States, and many still require nothing more than an unverified email address before allowing an individual to begin trading. Finally, decentralized platforms, peer-to-peer exchangers, and anonymity-enhanced cryptocurrencies that use non-public or private blockchains all can further obscure financial transactions from legitimate scrutiny. Many of these problems with blockchain cannot be solved immediately. However, there is a tremendous need for blockchain users to confidently and efficiently use their private key without it being lost or stolen by another person.

Data confidentiality, integrity, authentication, and non-repudiation are central goals of the practice of present day cryptography. Mathematics, computer science, electrical engineering, communication science, and physics are involved in modern cryptography practices, which include electronic commerce, chip-based payment cards, digital currencies, passwords, PIN numbers, tokens, and various secure military communication applications. Currently, modern cryptography uses mathematical theory, computer science practices, computer devices, and cryptographic algorithms that are believed to be hard to break in any practical period of time, which would make the private information retain a value.

Prior to modern cryptography, cryptography was synonymous with encryption. Encryption is a process of converting information from a readable state to an unintelligible form. Encryption can also be defined as a process of converting ordinary information (called plaintext) into an unintelligible form (called ciphertext). Decryption is the process which reverses the encryption process. A cipher (or cypher) is a pair of algorithms that carry out the encryption and the reversing decryption. The detailed operation of a cipher is controlled both by the algorithm and, in each instance, by a “key”. The key is a secret which ideally is known only to the communicants. The key is usually a string of characters that is short enough so that it can be remembered by the user. The key is needed to decrypt the ciphertext.

The sender of an encrypted message would share the decoding technique only with intended recipients to preclude access from adversaries. The cryptography literature often uses the names Alice (“A”) for the sender, Bob (“B”) for the intended recipient, and Eve (“eavesdropper”) for the adversary. Enigma rotor cipher machines of World War I and early computer uses during World War II are notable examples. Until modern times, cryptography referred almost exclusively to encryption, as discussed above. The detailed operation of a cipher is controlled both by the algorithm and, in each instance, by a “key”. The key is usually a string of characters, which is needed to decrypt the ciphertext.

In formal mathematical terms, a “cryptosystem” is the ordered list of elements of finite possible plaintexts, finite possible cyphertexts, finite possible keys, and the encryption and decryption algorithms which correspond to each key. Keys are important both formally and in actual practice, as ciphers without variable keys can be trivially broken with only the knowledge of the cipher used and are therefore useless (or even counter-productive) for most purposes. Historically, ciphers were often used directly for encryption or decryption without additional procedures, such as authentication or integrity checks.

Generally, there are two kinds of cryptosystems: symmetric and asymmetric. Symmetric cryptography systems were the only ones known until the 1970s, so the same key (the secret key) is used to encrypt and decrypt a message. Data manipulation in symmetric systems is faster than in asymmetric systems in part due to the shorter key lengths. Asymmetric systems use a “public key” to encrypt a message and a related “private key” to decrypt it. Use of asymmetric systems enhances the security of communication, largely because the relation between the two keys is very hard to discover. Examples of asymmetric systems include a Rivest-Shamir-Adleman system (a RSA system) and an Elliptic Curve Cryptography system (ECC).

In an RSA system, the user creates and publishes a public key based on two large prime numbers, along with an auxiliary value. The prime numbers are kept secret. Messages can be encrypted by anyone, via the public key. However, the messages can only be decoded by someone who knows the prime numbers. The security of the RSA system relies on the practical difficulty of factoring the product of two large prime numbers. There are no published methods to defeat the system if a large enough key is used. Typical RSA key sizes are 1,024-4,096 bits. Furthermore, the RSA system is a relatively slow algorithm, and because of this, it is not commonly used to directly encrypt user data.

An ECC system is an approach to public-key cryptography based on the algebraic structure of elliptic curves over finite fields. The ECC system allows smaller keys compared to non-EC cryptography (based on plain Galois fields) to provide equivalent security. Elliptic curves are applicable for key agreement, digital signatures, pseudo-random generators and other tasks. Indirectly, they can be used for encryption by combining the key agreement with a symmetric encryption scheme.

Quality symmetric algorithms include the commonly used Advanced Encryption Standard (AES), which replaced the older Data Encryption Standard (DES). The term “code” is often used to mean any method of encryption or concealment of meaning. However, in cryptography, the term “code” has a more specific meaning: the replacement of a unit of plaintext (e.g., a meaningful word or phrase) with a code word (e.g., the term “wallaby” replaces “attack at dawn”). A cypher, in contrast, is a scheme for changing or substituting an element below such a level (e.g., a letter, or a syllable or a pair of letters or another variable symbol) in order to produce a cyphertext. Fundamentally, asymmetric cryptography is scalable for use in very large and ever expanding environments where data is frequently exchanged between different communication partners.

A number of fundamental concepts exist with asymmetric cryptography. First, during the practice of asymmetric cryptography, a user possesses two keys: a public key and a private key. Additionally, the public key and the private key are mathematically related and both keys together are called a “key pair.” Moreover, the private key is typically a random digital number in the form of bits, bytes, or hexadecimals, first created and the public key is made available to anyone while the private key is kept secret. Additionally, the public key and the private key are required to perform an operation. Also, data which has been encrypted using the public key can be unencrypted (decrypted) using the private key. The opposite procedure is also possible. Further, to ensure that a message has come from a stated sender, the data can be encrypted with the private key of the stated sender to create a digital signature. This is valid only if only the stated sender had access to the private key that created the digital signature.

A digital envelope is signing a message with a recipient's public key. Further, a digital envelope, which serves as a means of asymmetric cryptography (AC) by ensuring that only the intended recipient can open the message because only the receiver will have the private key necessary to unlock the envelope—this is also known as receiver authentication. If the private key is ever discovered, a new key pair must be generated. Asymmetric cryptography is often used to exchange the secret key to prepare for using symmetric cryptography to encrypt data. In the case of a key exchange, one party creates the secret key and encrypts it with the public key of the recipient. The recipient would then decrypt it with their private key. The remaining communication is done with the secret key being the encryption key. Asymmetric encryption is used in key exchange, email security, web security, and other encryption systems that require key exchange over the public network.

The options for authentication of a person's identity, which are operated on a mobile phone, include push-based authentication, Quick Response (QR) code-based authentication, one-time password authentication, which is event-based and time-based, and SMS-based verification. SMS-based verification has security concerns because mobile phones can be cloned, applications (or apps) can run on several mobile phones, mobile phone maintenance personnel can read SMS texts, and the mobile phone can be compromised in general so that the mobile phone is no longer something only the user has.

A major drawback of authentication can be that the user must carry around the physical token (e.g., the USB stick, the bank card, the key or similar), practically at all times. Physical tokens can be lost or stolen. Some organizations forbid carrying USB and electronic devices in or out of their premises due to malware and the risks of data theft. Further, high security computers intentionally lack USB ports to lessen exposure to malware and data theft for the same reason. Physical tokens may not be usable in new accounts and systems.

Two-step authentication involving mobile phones and smartphones is based on a person using their personal access codes to their phone and a one-time-valid, dynamic digital passcode sent to their phone by a short message service (or SMS or a “text message”) or generated by a one-time passcode-generator app. Two-step authentication side-steps the need for an additional dedicated token, as users tend to carry their mobile devices around at all times. As of 2018, SMS is the most broadly-adopted multi-factor authentication method for consumer-facing accounts.

Some advantages of SMS include: no additional tokens are necessary because it uses mobile devices that are (usually) carried all the time and constantly changed, dynamically generated passcodes are safer to use than fixed (static) log-in information. Additionally, depending on the solution, passcodes that have been used are automatically replaced in order to ensure that a valid code is always available, transmission/reception problems do not therefore prevent logins.

However, as a disadvantage of SMS, users may still be susceptible to phishing attacks. An attacker can send a text message that links to a spoofed website that looks identical to the actual website. The attacker can then get the authentication code, user name, and password. A mobile phone is not always available—they can be lost, stolen, have a dead battery, or otherwise not work. Mobile phone reception is not always available—large areas, particularly outside of towns, lack coverage. SIM cloning gives hackers access to mobile phone connections. Social engineering attacks against mobile-operator companies have resulted in the handing over of duplicate SIM cards to criminals. Text messages to mobile phones using SMS are insecure and can be intercepted by so-called IMSI-catchers. Thus, third parties can steal and use the token.

Account recovery typically bypasses mobile-phone two-factor authentication. Modern smartphones are used both for receiving email and SMS. So if the mobile phone is lost or stolen and is not protected by a password or biometric identification method, all accounts for which the email is the key can be hacked as the mobile phone can receive the second factor. An advance in mobile two-factor authentication includes: a second factor can be implemented while not posing a hindrance to the user. With the continued use and improvements in the accuracy of mobile hardware such as global positioning system (GPS), microphone, and gyro/accelerometer, the ability to use them as a second factor of authentication is becoming more trustworthy. For example, by recording the ambient noise of the user's location from a mobile device and comparing it with the recording of the ambient noise from the computer in the same room in which the user is trying to authenticate, one is able to have an effective second factor of authentication.

One of the key problems in the world's growing technology architectures and internet dependencies is an individual's identity and access management (IAM). A requirement of a functional IAM system is that the system only allows one individual to have one digital identity. The digital identity of an individual needs to be not be stolen, however current IAM methods and systems are flawed and identity theft is occurring.

Digital identity is commonly used for authenticating an individual using a sensor device for reading personal attributes of an individual. Personal attribute reading devices include can include: touch screens and cameras to measure an individual's personal attributes such as their face, an iris, a fingerprint, or a naturally occurring biological signature, such as a venous blood supply map in a hand. Personal attributes of an individual are then auto-tagged to their personal information, including collections of histories of their personal behaviors and activities, and GPS locations. For example, Facebook uses facial recognition algorithms on a photograph of a person to auto-tag their face recognition data to their personal information data. The creation of vast facial recognition databases by public and private companies is a problem because personal attributes are not unique in sets of over 100 million people. Although making a scan of one's face is an insecure and vulnerable factor in IAM, millions of people have freely given up pictures of themselves and personal information to social media companies. Such pictures of individuals and their personal information are stolen by many companies and sold to other companies and to criminals. There is a need for improved IAM systems, methods and devices which are more secure, confidential, accurate, and precise, but remain affordable, rapid, and socially acceptable.

There is a commercially-driven nonstop gathering of personal attributes of an individual being auto-tagged to their personal information and habits. There are enormous databases on the Internet tabulating the personal identity information of many people who are consumers on the planet. Tabulated particularly in the databases of consumers is their personal consumer behavior and history, which is sold to advertising companies. Such consumer personal behaviors include: phone numbers and personal activities (such as where they live, work, vacation, dine, shop, family life, their friends, their email communications, twitter activity, Facebook activity, blog activity, the websites they visited, internet purchase, Amazon purchases, cell phone conversations, locations of their computers, locations of their cell phones, location of their cars, any GPS locations, they have visited, their estimated incomes, and credit scores). For example, Facebook uses facial recognition algorithms on a photograph of a person to auto-tag their face recognition data to their personal information data. Some of this personal information gathering is unstoppable at present because almost everyone is tied to some Internet activity use. As a consequence of this personal information gathering, the security of passwords, private documents or access tokens and other information that is present (stored) on a computer or mobile device is put at risk at being stolen and used in an unauthorized way, which in turn creates great risk to the user, such as disclosure of private information as well as commercial, medical, legal and financial harm.

Frank Miller in 1882 is credited with an encryption method called one-time pad (OTP) for encrypting a plaintext document into a ciphertext using a random, one-time use, secret key at least as long as the plaintext. In theory, an OTP cipertext cannot be cracked. However, being sure that the OTP key is: (a) truly random, (b) at least as long as the plaintext, (c) never reused in whole or in part, and (d) kept completely secret is impractical.

First, a truly random key, as opposed to a pseudorandom key which is as long as the plaintext, one-time pad key is possible but a non-trivial requirement although true random number generators exist, they are often too slow for modern computing and e-commerce, and other, more specialized applications. Secure generation and exchange of the one-time pad values, which must be at least as long as the message. The security of the one-time pad is only as secure as the security of the one-time pad exchange, because if an attacker is able to intercept the one-time pad value and know it is a one-time pad, they can decrypt the one-time pad's message. Careful treatment to make sure that the one-time pad values continue to remain secret and are disposed of correctly, preventing any reuse in whole or in part—hence “one-time”. One-time pads solve few current practical problems in cryptography. The present invention has been designed to solve many of these aforementioned problems.

### Review of Related Technology:

WO2015171450A1 describes a method and apparatus for embedding a graphic image representation into a two dimensional matrix code by modifying the characteristic values of individual pixels in the image according to the values of a provided two dimensional matrix code image. The modified character pixel values are determined using an optimization procedure that minimizes a visual distortion with respect to the original graphic image representation while maintaining the value of a probability of error model below a specified limit.

U.S. Pat. No. 10,089,508B2 describes a technique to embed a graphic representation and/or a concealed message, such as, but not limited to, two dimensional codes such as quick response (QR) code matrices, fingerprints, coded fingerprint representations, iris imagery, iris coded representation, biometric hashes, palm print or portraits into a QR matrix code.

U.S. Pat. No. 10,372,962B2 describes techniques, including circuits and designs, which can receive information with respect to fingerprint images, or portions thereof, and which can be incorporated into devices using fingerprint recognition. This application also provides techniques, including devices which perform fingerprint recognition and methods which can be performed by those devices.

U.S. Pat. No. 10,373,013B2 describes systems and methods for identifying an object and presenting additional information about the identified object.

U.S. Pat. No. 9,528,144B2 describes polymer microparticles spatially and spectrally encoded using upconversion nanocrystals (UCN) for labeling of articles and tissues. UCN having spectrally distinguishable emission spectra are disposed in different portions of an encoding region of each microparticle.

U.S. Pat. No. 10,832,110B2 and U.S. Pat. No. 10,152,663B2 describe a technique, referred to as Secure QR Codes, which not only provides aesthetically enhanced QR codes, but also allows for security. It can embed a standard black and white QR code, referred to as a public QR code, and a secret QR code, both into a secure QR code. The secure QR code produced is composed of colored cells. The public black and white QR code must first be, either aesthetically enhanced into an enhanced colored QR code, or transformed into a colored QR code with cells of uniform color obtained by transforming each of the black and white cells of the public QR code into cells that takes a color from a subset of possible colors, such that the luminance of each colored cell approximates accurately the black or white luminance values of the public QR code.

U.S. Pat. No. 10,523,652B2 describes a method for performing, by a personal computing device, a secure handshake with a secure server accessible through an identity provider to log into the secure server. A temporary identity (TID) token can be received at the personal computing device a from an identity provider system over a telecommunications network. The TID token can be encrypted using a cryptographic key stored in a hardware storage element of the personal computing device. The encrypted TID token can be transmitted to a connected wearable device across a Bluetooth connection or other connection protocol. When a user wishes to log into a network location accessible through the identity provider, the wearable device can provide the encrypted TID token to the computing device. The personal computing device can decrypt the encrypted TID token and use the decrypted TID to access the network location.

WO2015112493A1 describes an authentication device includes at least one processor, at least one computer-readable medium, and program instructions stored on the at least one computer-readable medium for execution by the at least one processor. The program instructions include first program instructions to wirelessly pair the authentication device with a controlled access device. The program instructions further include second program instructions to broadcast data indicative of an authorization to grant access to the controlled access device, while the controlled access device is within a predefined range of the authentication device, upon successfully pairing with the controlled access device.

WP2013166377A1 describes a system and method that provides auxiliary voice input to a mobile communication device (MCD). The system comprises an electronic skin tattoo capable of being applied to a throat region of a body. The electronic skin tattoo can include an embedded microphone; a transceiver for enabling wireless communication with the MCD; and a power supply configured to receive energizing signals from a personal area network associated with the MCD. A controller is communicatively coupled to the power supply. The controller can be configured to receive a signal from the MCD to initiate reception of an audio stream picked up from the throat region of the body for subsequent audio detection by the MCD under an improved signal-to-noise ratio than without the employment of the electronic skin tattoo.

US20200359204A1 describes a satellite device that can be associated with a user account of a minor aged (e.g., child or adolescent) user that does not have a smartphone that can be used as a companion device to the satellite device. The satellite device can be configured to be used as a primary device, without reliance upon a paired smartphone. Certain information can be synchronized with the satellite device via the association with the family account. During initial configuration, a set of cryptographic keys can be generated to associate the account of the satellite device with the set of accounts in the family. The satellite device can then access calendars, media, or other data that is shared with user accounts within a family of user accounts.

Various similar systems exist. However, their means of operation are substantially different from the present disclosure, as the other inventions fail to solve all the problems taught by the present disclosure.

### SUMMARY OF THE EMBODIMENTS

The present invention and its embodiments relate to rapid cryptography methods and devices for secure data access.

A first embodiment of the instant invention describes a method executed by a computing device. The computing device is a smartphone, a laptop computer, a desktop computer, a tablet computer, a personal computer, or a wearable computer. The wearable computer is a smart watch, a smart bracelet, a smart wristband, a smart ring, a smart necklace, or an eyeglasses computer. It should be appreciated that these examples are provided for illustrative purposes only and this list is non-exhaustive. In preferred examples, the computing device comprises the smartphone.

In response to a user launching an application on the computing device, the computing device housing a first data matrix, and holding the computing device over a location of a second data matrix external to the computing device, the method includes reading, by the computing device, the second data matrix. In examples, the location comprises a biological location. In these examples, the biological location is a body of a human, a skin of the human, a body of an animal, or a skin of the animal. In other examples, the location comprises a non-biological location. In these examples, the non-biological location includes: a device, a computer location, a surface, a home, a book, an office, outdoors, a piece of clothing, a painting, a wallpaper, a painted surface, a tool, or an article of manufacture, among others.

The method also includes processing the second data matrix utilizing the first data matrix such that the first data matrix provides a means for stepping through the second data matrix to create a private key and utilizing the private key to unlock user data stored in the application. The private key is erased immediately after the private key is created and used.

The second data matrix comprises a data matrix patch, where the data matrix patch comprises dots containing up-converting particles (UCPs). The data matrix patch is a biocode that consists of an encoding protocol resembling a two-dimensional pattern of a QR matrix code that is invisible to a human eye until exposed to one or more beams of infrared light or visible excitation light from a source. The source may be a light emitting dioide (LED) of the computing device, a vertical-cavity surface-emitting laser (VCSEL) emitter of the computing device, an external attachment to the computing device, or a passive device connected to the computing device, among others.

A second embodiment of the present invention describes a method executed by a user. The method includes numerous process steps, such as: launching an application on the computing device, where the computing device houses a first data matrix, holding the computing device over a location of a second data matrix external to the computing device, and moving the computing device to display application icons. The second data matrix is invisible to a human eye. The location is a biological location, and preferably a skin of a human. The movement of the computing device to display the application icons includes: a transverse motion in an x direction and a y direction of dimensions of the computing device, a rotational motion within an image plane of the computing device around an axis perpendicular to the dimensions of the computing device, and/or a tilting motion around an axis aligned with a longest dimension of the computing device, among others.

The method also includes: selecting an icon from the application icons associated with a desired account, reading, via the computing device, the second data matrix, processing, via the computing device, the second data matrix utilizing the first data matrix such that the first data matrix provides a means for stepping through the second data matrix to create a private key, and utilizing, via the computing device, the private key to unlock user data stored in the desired account.

It should be appreciated that the second data matrix is received at the location by: positioning a data matrix patch of up-converting particle (UCP)-tipped microneedles over the skin of the human, pushing the data matrix patch into the skin of the human, removing the data matrix patch from the skin of the human, and leaving UCP tips of the UCP-tipped microneedles embedded in the skin of the human such that the data matrix patch is installed beneath a surface of the skin of the human. After the skin of the human heals, an epidermis or dermis of the human contains the UCPs in a pattern as a biocode matrix.

Moreover, the biocode matrix consists of an encoding protocol resembling a two-dimensional (2D) pattern of a QR matrix code that is invisible to a human eye until exposed to one or more beams of infrared light or visible excitation light from a source. The source is a light emitting dioide (LED) of the computing device, a vertical-cavity surface-emitting laser (VCSEL) emitter of the computing device, an external attachment to the computing device, or a passive device connected to the computing device, among others.

In some examples, the 2D pattern is a defined grid formation readable by one or more software and/or programs of the computing device. In other examples, the 2D pattern is a grid or is randomly generated and unreadable by one or more software and/or programs of the computing device.

Moreover, in some examples, dimensions of the data matrix patch are selected from the group consisting of: approximately 1-10 mm², approximately 10-100 mm², approximately 100-1000 mm², approximately 1000-10,000 mm², or larger than approximately 10,000 mm². In preferred examples, the dimensions of the data matrix patch are approximately 1-10 mm². In other examples, the dimensions of the data matrix patch are approximately 7×7 mm². In some examples, a quantity of the UCP-tipped microneedles in the data matrix patch is approximately 10-100 microneedles, approximately 100-1000 microneedles, approximately 1000-10,000 microneedles, approximately 10,000-100,000 microneedles, approximately 100,000-1 million microneedles, or more than 1 million microneedles. In other examples, an ink jet unit moves relative to unfilled microneedles in a pattern and dispenses fluid droplets comprising UCPs into the unfilled microneedles to fill the UCP-tipped microneedles.

A third embodiment of the present invention describes a method for generating a random number for use in creating a data matrix. The method includes numerous process steps, such as: selecting, by a user, a method for generating a random number and using a random number generator for obtaining the random number. The method also includes the user selecting a type of data matrix, a location for the data matrix, and a number of quadrants for the data matrix. Further, the method includes using the random number to create a data matrix. The data matrix may include a 16×16 random binary data matrix of ones and zeroes. The location may include a biological location or a non-biological location. Further, the random number may be a 256 bit random number.

A fourth embodiment of the present invention describes a method executed by a computing device to encrypt large documents rapidly with elliptic curve cryptography (ECC). The method includes numerous process steps, such as: calculating a temporary public key for a temporary private key Pⁱ by using a first equation of Pⁱ (Xⁱ,Yⁱ)=r₂ⁱG₀, where G₀ is a generator point for an elliptic curve. Next, the method includes: imbedding hexadecimal strings into an X value of the first equation for the public key by using a second equation of Jⁱ=Xⁱ−sᵢ. The method also includes: replacing each sᵢ with Jⁱ, constructing a temporary private key r₁, and computing a public key and an additional point using a third equation of P₁=r₁ G₀ and a fourth equation of P₂=r₁P. The P comprises a user's public key corresponding to a biocode. The biocode comprises the user's unknown and unknowable private key. The method also includes: utilizing a modular point addition to create and hide a database of points used to imbed an original string such that for each i, a fifth equation of Pⁱ=Pⁱ(Xⁱ,Yⁱ)+P₂ is used. All Pⁱ and all Jⁱ are added to the database.

Moreover, the method may further include: scanning a data matrix at a location external to the computing device to compute a private key k and engaging in a decryption process to recover imbed points by using a sixth equation of Pⁱ (Xⁱ, Yⁱ)+P₂−kP₁ , where P=k G₀. The method may also include recovering original 32 byte plaintext segments from Xⁱ values of the imbed points by a seventh equation of sᵢ=Xⁱ−Jⁱ.

The method for the encryption of the large documents rapidly with the ECC utilizes a secp256k1 version of ECC. Furthermore, it should be appreciated that the Pⁱ is created in a volatile memory of the computing device.

### BRIEF DESCRIPTION OF THE DRAWINGS

FIG. 1 depicts a graph showing an effect of infrared (IR) light irradiation on up-converting particles (UCPs), according to at least some embodiments disclosed herein.

FIG. 2 depicts a schematic diagram and a top view of a 16×16 two-dimensional (2D) data matrix with random positioned black dots and white dots, according to at least some embodiments disclosed herein.

FIG. 3 depicts a schematic diagram and a top view of a 29×29 2D quick response (QR) code of dots with fiduciary marks at an upper left apex, an upper right apex, and a lower left apex of the QR code dots, according to at least some embodiments disclosed herein.

FIG. 4 depicts a schematic diagram and a top view of a square having four quadrants where each of the quadrants comprises a 16×16 2D data matrix of dots, according to at least some embodiments disclosed herein.

FIG. 5 depicts a schematic diagram and a top view of a square containing four quadrants with each quadrant comprising a 29×29 2D QR Code of dots, according to at least some embodiments disclosed herein.

FIG. 6 depicts a schematic diagram of a strip containing a line having four quadrants with each quadrant comprising a 16×16 2D data matrix of square dots, according to at least some embodiments disclosed herein.

FIG. 7 depicts a schematic diagram and a top view of a strip containing a line having four quadrants with each quadrant comprising a 29×29 2D QR code of square dots, according to at least some embodiments disclosed herein.

FIG. 8 depicts a schematic diagram and a top view of an oval patch comprising four closely positioned quadrants with each quadrant comprising a 16×16 data matrix and where the dots are depicted as a random dot pattern of black round dots on a white background, according to at least some embodiments disclosed herein.

FIG. 9 depicts a schematic diagram of a square on an oval QR code patch comprising four closely positioned quadrants with each quadrant comprising each a 16×16 data matrix of a random pattern of black dots on a white patch background, according to at least some embodiments disclosed herein.

FIG. 10 provides a cross-sectional view of a highly simplified schematic depiction of a mobile phone separated by an air gap and with a cross-sectional view of a data matrix dot containing UCPs next to a data matrix dot that comprises a dot composition having no UCPs, according to at least some embodiments disclosed herein.

FIG. 11 depicts a schematic diagram and a biocode 16×16 data matrix of microneedles in a random pattern, where the microneedles contain UPCs, according to at least some embodiments disclosed herein.

FIG. 12 depicts a cross-sectional view of a process involving UCP-tipped microneedles as part of a biocode data matrix, according to at least some embodiments disclosed herein.

FIG. 13 depicts a block diagram of a method for acquiring a UCPs data matrix information on a mobile device, according to at least some embodiments disclosed herein.

FIG. 14 depicts a block diagram of a method for binarizing data matrix quadrant light dots, according to at least some embodiments disclosed herein.

FIG. 15 depicts a block diagram of a method for using binary array information in a volatile memory of a mobile device which has been obtained from a UCPs light pattern detected by a mobile device camera, according to at least some embodiments disclosed herein.

FIG. 16 depicts a schematic diagram of a 25 rows×400 columns rectangular data matrix with left-side finder patterns and right-side finder patterns, according to at least some embodiments disclosed herein.

FIG. 17 depicts a schematic diagram of an Aztec 53×53 dots matrix with a center fiduciary mark and UCPs dots data arranged in a spiral pattern around the center fiduciary, according to at least some embodiments disclosed herein.

FIG. 18 depicts a schematic diagram of a finite modulo square small array table, according to at least some embodiments disclosed herein.

FIG. 19 depicts a schematic diagram of a second factor array process used in a method for creating a private key, according to at least some embodiments disclosed herein.

FIG. 20 depicts a block diagram of a method for generating a quantum random number, according to at least some embodiments disclosed herein.

FIG. 21 depicts a block diagram of a highly schematic algorithm for selecting and manufacturing a data matrix patch for a non-biological location, according to at least some embodiments disclosed herein.

FIG. 22 depicts a block diagram of a highly schematic algorithm for selecting and manufacturing a data matrix patch for a biological location, according to at least some embodiments disclosed herein.

FIG. 23 depicts a schematic diagram of a simple public key cryptography used with a public key to encrypt a short plaintext document as a means for creating a ciphertext document, and then using a unique related private key to decrypt the ciphertext back to the original plaintext, according to at least some embodiments disclosed herein.

FIG. 24 depicts a schematic diagram of a method of filling an inverted array of initially unfilled microneedles in a shape of a letter “E” arranged along a grid in x and y directions, according to at least some embodiments disclosed herein.

FIG. 25 depicts a schematic diagram of an array of filled microneedles, according to at least some embodiments disclosed herein.

FIG. 26 depicts a schematic diagram of a mobile device or a smartphone, when viewed from a side, of an light emitting diode (LED) or a vertical-cavity surface-emitting laser (VCSEL) emitter that is emitting infrared or visible excitation light from the mobile device or the smartphone's surface, according to at least some embodiments disclosed herein.

FIG. 27 depicts a schematic diagram of a side-view of a mobile device or a smartphone performing a line scan of an external data matrix using infrared or visible excitation light emitted from the mobile device or the smartphone LED or VCSEL emitter, according to at least some embodiments disclosed herein.

FIG. 28A depicts a schematic diagram of a mobile device or a smartphone that is pointed at a wrist of a user with an electromagnetic excitation directed at a location of an external data matrix and a list of application icons displayed on a screen of the mobile device or the smartphone, according to at least some embodiments disclosed herein.

FIG. 28B depicts a schematic diagram of a transverse motion (in the x and y direction of the smartphone's dimensions) that can be used to scroll through a list or grid display of icons, according to at least some embodiments disclosed herein.

FIG. 28C depicts a schematic diagram of a rotational motion within the smartphone's image plane (around an axis perpendicular to the smartphone's dimension) that can be used to scroll through a list or grid display of icons, according to at least some embodiments disclosed herein.

FIG. 28D depicts a schematic diagram of a tilting motion around an axis aligned with the smartphone's longest (vertical) dimension that can be used to scroll through a list or grid display of icons, according to at least some embodiments disclosed herein.

FIG. 29A depicts a schematic diagram of an array of displayed application icons on a mobile device, a smartphone, or a smartwatch that are of different sizes depending on their location on the screen, according to at least some embodiments disclosed herein.

FIG. 29B depicts a schematic diagram of an array of displayed application icons on a mobile device, a smartphone, or a smartwatch that are all of equal size, according to at least some embodiments disclosed herein.

FIG. 29C depicts a schematic diagram of a transverse motion (in the x and y direction of the mobile device or the smartphone's dimensions) that can be used to scroll through a list or grid display of icons, according to at least some embodiments disclosed herein.

FIG. 30 depicts a block diagram of a computing device, according to at least some embodiments disclosed herein.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

### Nanoparticles

Various kinds of nanoparticles (NPs) are used for fluorescent imaging. See, Otto S. Wolfbeis, “An Overview of Nanoparticles Commonly used in Fluorescent Bioimaging,” Chem. Soc. Rev., 2015, 44, Pages 4743-4768, DOI: 10.1039/C4CS00392F, the entire contents of which are hereby incorporated by reference in their entirety. Fluorescent NPs provide benefits over molecular fluorophores, labels, and probes that are often used in bioimaging. NPs include fluorescently doped silicas and sol-gels, hydrophilic polymers (hydrogels), hydrophobic organic polymers, semiconducting polymer dots, quantum dots, carbon dots, other carbonaceous nanomaterials, upconversion NPs, noble metal NPs (mainly gold and silver), and dendrimers.

The term “fluorescence” includes a variety of techniques where images can be acquired by measurement of intensity, decay time, and polarization. Chemo- and bioluminescence are both time-dependent and can also generate images, but chemiluminescence requires the addition of reagents and usually is unidirectional in that an increase in the concentration of an analyte can only be monitored. See, Otto S. Wolfbeis.

### Fluorescently Doped Silicas and Sol-Gels

Silica nanoparticles (SiNPs) are used in bioimaging. See, Otto S. Wolfbeis; and Kemin Wang, et al., “Functionalized silica nanoparticles: a platform for fluorescence imaging at the cell and small animal levels,” Acc. Chem. Res., 2013, 46(7), Pages 1367-1376, DOI: 10.1021/ar3001525, the entire contents of which are hereby incorporated by reference in their entirety. SiNPs can be doped with various kinds of organic, metal-organic and metallic fluorophores, and emission wavelengths range from 300 to 1000 nm. See, Heike Mader, et al., “Fluorescent Silica Nanoparticles,” Ann. N.Y. Acad. Sci. 2008,1130, Pages 218-223, DOI: 10.1196/annals.1430.053, the entire contents of which are hereby incorporated by reference in their entirety.

Color, decay, times and size are widely modifiable, and dopants can be hydrophobic, hydrophilic, or ionic. See, Otto S. Wolfbeis. SiNPs also may be coated with fluorophores. Two-photon excitation has been demonstrated and depends on the kind of fluorescent label. See, Otto S. Wolfbeis. SiNPs and their aggregates of >300 nm in size cause strong light scattering. SiNPs are biocompatible and cell permeability depends on zeta potential. If negatively charged, they hardly pass cell membranes. See, Otto S. Wolfbeis. SiNPs are virtually nontoxic, easily excreted (unless particle sizes exceed 50 nm), and also quickly coated by intracellular proteins and attacked by the immunosystem. See, Otto S. Wolfbeis. Their surface can be easily modified with a variety of coatings and using standard silica (and sol-gel) surface chemistry.

SiNPs and other NPs are often doped with luminescence lanthanides. See, Otto S. Wolfbeis. The lanthanide or lanthanoid series of chemical elements comprises the 15 metallic chemical elements with atomic numbers 57-71, from lanthanum through lutetium. These elements, along with the chemically similar elements scandium and yttrium, are often collectively known as the “rare earth elements.” Their use in bioimaging has been reviewed, as well as the fabrication of down-converting and up-converting luminescent probes for optical imaging. See, Xueyuan Chen, et al., Lanthanide Doped Luminescent Nanomaterials, Nanomedicine and Nanotoxicology, Springer Verlag, Berlin, 2014, ch. 7, pp. 145-164, DOI:10.1007/978-3-642-40364-4_7, the entire contents of which are hereby incorporated by reference in their entirety.

Lanthanide-based fluorophores have attractive features such as (a) relatively long decay times that facilitates time-resolved fluorometry and, thus, efficient background suppression; (b) fairly narrow emissions; (c) single-photon and two-photon excitation; and (d) upconversion luminescence and downconversion luminescence. See, Otto S. Wolfbeis. Lanthanide doped SiNPs are obtained by incorporating lanthanide ions, or by grafting the SiNPs with complexes such as Eu(III), Tb(III) or Gd(III). See, Sonia L. C. Pinho, et al., “Lanthanide-DTPA grafted silica nanoparticles as bimodal-imaging contrast agents,” Biomaterials, 2012, 33(3), Pages 925-935, the entire contents of which are hereby incorporated by reference in their entirety. Such fluorescent NPs have decay times between 0.35 and 1.87 ms (which facilitates gated spectroscopy), do not photobleach, and display the typical narrow emission bands of lanthanide ions.

Beads and bead aggregates of >300 nm in size cause strong light scattering. See, Otto S. Wolfbeis. Sol-gel NPs are biocompatible, which can be improved by PEGylation. Cell permeability depends on zeta potential in that NPs are hardly cell permeable if negatively charged. Sol-gel NPs are nontoxic and—if small enough—are easily excreted. See, Otto S. Wolfbeis. The surface of sol-gel NPs can be modified ex vivo with a variety of coatings, and the surface chemistry of silica and sol-gels is well established. Particles do not swell but tend to aggregate in the presence of bivalent ions if their zeta potential is negative. See, Otto S. Wolfbeis.

Hydrophobic Organic Polymers

Polystyrene nanoparticles (PS-NPs) are highly hydrophobic and can be doped with apolar fluorophores with emission peak wavelengths that range from the near UV to beyond 1000 nm. See, Otto S. Wolfbeis. The color, decay times and size also of PS-NPs are modifiable. Doping with lipophilic materials may be used. For the PS-NPs, fluorescence occurring at below 500 nm is interfered by the autofluorescence of biomatter. An (organic) dopant fluorophore can photobleach if exposed to strong laser light. PS-NPs are biocompatible (not harmful to cells and tissue), fairly well cell permeable, nontoxic, and their excretion is slow. If placed inside cells, they are only slowly coated by intracellular proteins and hardly attacked by the immunosystem. See, Otto S. Wolfbeis. Polyacrylonitrile (PAN) NPs can be doped with fluorophores with emission wavelengths ranging from 300 to 1000 nm, preferably with hydrophilic dyes. Moreover, PAN is biocompatible and cell-permeable, nontoxic, easily excreted but slowly coated by intracellular proteins and it is hardly attacked by the immunosystem. See, Otto S. Wolfbeis.

Biocompatible fluorescent organic NPs with tunable photoluminescence may be obtained via one-pot oxidation of polydopamine and then utilized for cell imaging. See, Xiaoyong Zhang, et al., “Biocompatible polydopamine fluorescent organic nanoparticles: facile preparation and cell imaging,” Nanoscale, 2012, 4, Pages 5581-5584; and Miao Luo, “Facile preparation of water dispersible red fluorescent organic nanoparticles for cell imaging,” Bulletin of the Korean Chemical Society (2014), 35(6), Pages 1732-1736, the entire contents of which are hereby incorporated by reference in their entirety. Quantum-dots conjugated to dopamine function as redox coupled assemblies and can be applied to in vitro and intracellular pH sensing. See, Igor L. Medintz, et al., “Quantum-dot/dopamine bioconjugates function as redox coupled assemblies for in vitro and intracellular pH sensing,” Nat. Mater., 2010, 9(8), Pages 676-84, DOI: 10.1038/nmat2811, the entire contents of which are hereby incorporated by reference in their entirety. Other polymers include poly(vinyl butyral) labeled with a perylene dyes that is easily taken up without coating and does not display in vitro cytotoxicity on human cancer cells. See, Damir Posavec, et al., “Polyvinyl butyral nanobeads: preparation, characterization, biocompatibility and cancer cell uptake,” Microchimica Acta (2011), 173(3-4), Pages 391-399, the entire contents of which are hereby incorporated by reference in their entirety.

### Semiconducting (Organic) Polymer Dots (P-Dots)

With P-dots, the polymer usually is prepared from aromatic precursors possessing polymerizable double or triple bonds and doping with fluorophores is unnecessary. See, Otto S. Wolfbeis. The backbone of conjugated polymers behaves like an array of light-harvesting units that exhibit a larger optical cross section compared to small organic molecule dyes. See, Otto S. Wolfbeis.

Fluorescent nanodots consisting of semiconducting polymer blends can be attached to peptides and then be used for targeted imaging in clinical diagnosis. See, Changfeng Wu, et al., “Design of highly emissive polymer dot bioconjugates for in vivo tumor targeting,” Angew Chem Int Ed Engl., 2011, 50(15), Pages 3430-4, DOI: 10.1002/anie.201007461, the entire contents of which are hereby incorporated by reference in their entirety. By coupling the pH-indicator fluorescein to P-dots, a material is obtained that displays two fluorescence peaks, one being pH sensitive, the other not so that it can acts as an internal reference. See, Otto S. Wolfbeis.

### Carbon Dots (C-Dots)

C-dots are defined as clusters of carbon atoms with diameters of 2 to 8 nm that also contain substantial fractions of oxygen and hydrogen, if not nitrogen. See, Sheila N. Baker, et al., “Luminescent carbon nanodots: emergent nanolights,” Angew Chem Int Ed Engl., 2010, 49(38), Pages 6726-44, DOI: 10.1002/anie.200906623; and Mitchell Bacon, et al., “Graphene Quantum Dots,” Particle & Particle Systems Characterization (2014), 31(4), Pages 415-428, the entire contents of which are hereby incorporated by reference in their entirety. C-dots can be made strongly fluorescent and need not be doped or labeled. Their emission color can be tuned by varying the experimental conditions of synthesis. Both the excitation and emission spectra are very wide and usually extend from the UV to 650 nm. See, Otto S. Wolfbeis. Further, the fluorescence of C-dots can be of the upconversion and the down-conversion type. See, Otto S. Wolfbeis. In terms of synthesis, both top-down and bottom-up approaches are known. The resulting C-dots contain substantial fractions of oxygen (up to 50%) and nitrogen if a nitrogen-containing substance such as an amino acid is added during synthesis. See, Otto S. Wolfbeis.

### Metal Chalcogenide Quantum Dots (Classic Q-Dots)

Classic Q-dots are made from combinations of zinc(II), cadmium(II), selenide and sulfide. See, Otto S. Wolfbeis. Q-dots do not need to be doped with fluorophores because their fluorescence results from a photonic quantum effect. The color of emission and their size are tunable and interdependent. Decay times (in the low ns time domain), in contrast, do not vary much. Furthermore, Q-dots display Gaussian emission spectra (with FWHMs of typically 30 nm) and therefore have multiplexing capacity (like upconverting NPs but unlike C-dots).

All Q-dots require photoexcitation at <500 nm, where biomatter often strongly absorbs and fluorescence intensity strongly varies over time. The quantum yield (QY) of Cd/Zn based Q-dots is rather high (0.3-1.0) which is distinctly better than the QYs of upconversion NPs. Dots and aggregates of >300 nm in size cause strong light scattering. Single photon, 2-photon, and 3-photon excitation and imaging have been demonstrated. See, Otto S. Wolfbeis.

Q-dots are cell toxic unless coated with inert shells, but passivation and reduced toxicity of CdS dots also were accomplished by coating them with DNA. See, Nan Ma, et al., “DNA-passivated CdS nanocrystals: luminescence, bioimaging, and toxicity profiles,” Langmuir., 2007, 23(26), Pages 12783-7, DOI: 10.1021/1a7017727, the entire contents of which are hereby incorporated by reference in their entirety. Q-dots are cell permeable, but clearance from tissue is difficult, partially due to their interaction with thiol groups of cysteines in proteins. See, Ming Cao, et al., “Selective fluorometry of cytochrome c using glutathione-capped CdTe quantum dots in weakly basic medium,” Microchimica Acta (2009), 165(3-4), Pages 341-346, the entire contents of which are hereby incorporated by reference in their entirety. They are uniquely suited for high resolution and multiplexed imaging of cells. See, Eleonora Petryayeva, et al., “Quantum dots in bioanalysis: a review of applications across various platforms for fluorescence spectroscopy and imaging,” Appl. Spectrosc., 2013, 67(3), Pages 215-52, DOI: 10.1366/12-06948; Sandra J. Rosenthal, et al., “Biocompatible quantum dots for biological applications,” Chem. Biol., 2011, 18(1), Pages 10-24, DOI: 10.1016/j.chembiol.2010.11.013; Nan Chen, et al., “The cytotoxicity of cadmium-based quantum dots,” Biomaterials, 2012, 33(5), Pages 1238-44, DOI: 10.1016/j.biomaterials.2011.10.070; and Nan Ma, et al., “Nucleic acid-passivated semiconductor nanocrystals: biomolecular templating of form and function,” Acc. Chem. Res., 2010, 43(2), Pages 173-80, DOI: 10.1021/ar900046n, the entire contents of which are hereby incorporated by reference in their entirety.

### Upconversion Nanoparticles/Upconversion Particles (UCPs)

Most UCPs consist of hexagonal NaYF4 nanocrystals doped with trivalent lanthanide ions such as Er(III), Yb(III) or Tm(III). See, Otto S. Wolfbeis. The dopant is the emitter and additional doping with fluorophores is not needed. UCPs display several emission colors whose peak wavelengths depend on the kind of lanthanide dopant. See, Otto S. Wolfbeis. The size of UCPs is modifiable with typical sizes ranging from 10 to 100 nm. See, Otto S. Wolfbeis.

Most UCPs display multi-photon (bicolor) emissions. See, Otto S. Wolfbeis. Their dual (or multiple) emissions often enable referenced (2-wavelength) sensing and imaging, but the ratio of the two emissions (often green and red) varies with the coating and undergoes a change if hydrophobic particles of the oleate type are converted into hydrophilic particles (as preferably used in bioimaging). The use of upconversion NPs in bioimaging, therapy, drug delivery and bioassays has been reviewed. See, Otto S. Wolfbeis.

Unlike in the case of carbon dots, the color of the emission of UCPs is independent of the excitation wavelength, which is between 750-1000 nm. UCPs with oleate capping possess moderate brightness only, but those modified with hydrophilic coatings are much less bright, with QYs that hardly exceed 0.5% in water solution. Quantum yields of 1-3% have also been reported, but only for bulk materials or for dried and aggregated particles. The seemingly poor quantum yields of UCPs are acceptable because their anti-Stokes emission allows fluorescence images to be acquired against a black background. See, Otto S. Wolfbeis.

Furthermore, the quantum yields of UCPs also depend on the power density of the laser and on particle size, with smaller particles of the same kind displaying smaller QYs. See, M. Pollnau, et al., “Power dependence of upconversion luminescence in lanthanide and transition-metal-ion systems,” Physical Review B: Condensed Matter and Materials Physics (2000), 61(5), Pages 3337-3346, the entire contents of which are hereby incorporated by reference in their entirety. The brightness under single-particle imaging conditions is much higher than that of other compositions. See, Otto S. Wolfbeis.

UCPs may also be applied to optically encode and to multiplexed imaging of cells and microspheres. See, Hans H. Gorris, et al., “Photon-upconverting nanoparticles for optical encoding and multiplexing of cells, biomolecules, and microspheres,” Angew Chem Int. Ed. Engl., 2013, 52(13), Pages 3584-600, DOI: 10.1002/anie.201208196, the entire contents of which are hereby incorporated by reference in their entirety. UCPs are suited for bioimaging because fluorescence is not interfered by the autofluorescence of cells. See, Heike S. Mader, et al., “Upconverting luminescent nanoparticles for use in bioconjugation and bioimaging,” Curr Opin Chem Biol, 2010, 14(5), Pages 582-96, DOI: 10.1016/j.cbpa.2010.08.014, the entire contents of which are hereby incorporated by reference in their entirety.

Moreover, they are fairly biocompatible and—if small enough—cell permeable. They are not known to be toxic and easily excreted. They usually are weakly interacting with proteins, but can be well conjugated to them. UCPs are rarely attacked by the immunosystem, and their surface can be easily modified. They do not swell but tend to aggregate in the presence of bivalent ions. See, Otto S. Wolfbeis. Furthermore, their luminescence is highly dependent on temperature and (rather unselectively) quenched by several heavy metal ions. See, Sayed M. Saleh, et al., “Quenching of the luminescence of upconverting luminescent nanoparticles by heavy metal ions,” Chemistry, 2011, 17(51), Pages 14611-7, DOI: 10.1002/chem.201101860, the entire contents of which are hereby incorporated by reference in their entirety.

Photoexcitation of UCPs with lasers of wavelengths above 800 nm can lead to local heating, which can represent a substantial source of error in quantitative fluorometry. See, Otto S. Wolfbeis. If excited with NIR lasers, UCPs heat up. This can be desired or not. See, Otto S. Wolfbeis. It is not desired in the case of bioimaging, and an excitation wavelength of 915 nm was recommended to reduce laser induced heating of UCPs of the type NaYbF4:Tm,Er,Ho for deeper in vivo imaging. See, Otto S. Wolfbeis. The upconversion effect occurs at excitation wavelengths of around 800-820 nm, and this can strongly reduce sample heating and overtone IR absorption by water. See, Otto S. Wolfbeis.

### Dendrimers, Lipid Drops and Micelles

Dendrimers (dendrites) are a type of NPs that can be both hydrophilic and hydrophobic and are easily internalized by cells. Their fluorescence usually originates from a label that has to be attached to the hyperbranched dendrimer skeleton such that no self-quenching does occur. See, Otto S. Wolfbeis. Nanoscopic fluorescent dendrimers were designed that carry up to 96 two-photon chromophores and show very large two-photon absorption cross-sections(up to 56 [thin space (1/6-em)]000 GM units). See, Olivier Mongin, et al., “A modular approach to two-photon absorbing organic nanodots: brilliant dendrimers as an alternative to semiconductor quantum dots?,” Chem. Commun., 2006, Pages 915-917, the entire contents of which are hereby incorporated by reference in their entirety. Such organic nanodots are said to represent alternatives to semiconductor quantum dots.

In a typical example of its use in imaging, a dendrimer-based fluorescent pH probe was used to visualize pH values in living HeLa cells. See, Lorenzo Albertazzi, et al., “Delivery and subcellular targeting of dendrimer-based fluorescent pH sensors in living cells,” J. Am. Chem. Soc., 2010, 132(51), Pages 18158-67, DOI: 10.1021/ja105689u, the entire contents of which are hereby incorporated by reference in their entirety. In addition to dye-labeled dendrimers, some groups report autofluorescent hyperbranched poly(amido amine) NPs and their application to cell imaging. See, Wen Yang, et al., “Multiple functional hyperbranched poly(amido amine) nanoparticles: synthesis and application in cell imaging,” Biomacromolecules, 2011, 12(5), Pages 1523-31, DOI: 10.1021/bm1014816, the entire contents of which are hereby incorporated by reference in their entirety.

### Other Nanomaterials

Numerous other materials have been described for use as fluorescent NPs, such as: metal oxides, sulfides, tellurides, fluorides, and complex ionic species (including more than one cation and anion). See, Otto S. Wolfbeis. As an example, fluoridated hydroxyapatites (HAps) were doped with Eu(III) or Tb(III) that were shown to be viable NPs for cell imaging. See, Junfeng Hui, et al., “Fluoridated HAp:Ln3+(Ln=Eu or Tb) nanoparticles for cell-imaging,” Nanoscale, 2012, 4, Pages 6967-6970, the entire contents of which are hereby incorporated by reference in their entirety. They were made water-dispersible by hydrophobic/hydrophilic transformation with the surfactant Pluronic™ F127. Similar NPs were obtained by PEGylation of fluoridated HAp nanorods doped with Ln(III) and used for cell imaging. See, Xiaoyong Zhang, et al., “PEGylation of fluoridated hydroxyapatite (FAp):Ln3+nanorods for cell imaging,” Polym. Chem., 2013, 4, Pages 4120-4125, the entire contents of which are hereby incorporated by reference in their entirety.

Moreover, titanium dioxide (“titania”) is easily prepared and doped (e.g., with europium(III)) and respective TiO₂ hollow nanoshells are viable two-photon nanoprobes. Fluorescent Ag₂S nanoclusters possess tunable photoluminescence that extends from the red to the NIR. They can be made biocompatible and applied to bioimaging by introducing glutathione as the capping reagent. See, Chuanxi Wang, et al., “Facile aqueous-phase synthesis of biocompatible and fluorescent Ag₂S nanoclusters for bioimaging: tunable photoluminescence from red to near infrared,” Small., 2012, 8(20), Pages 3137-42; DOI: 10.1002/smll.201200376, the entire contents of which are hereby incorporated by reference in their entirety.

Two-photon excitable CaF₂ NPs doped with Tm(III) and Yb(III) represent nanoprobes for deep-tissue fluorescence bioimaging. See, Ning-Ning Dong, et al., “NIR-to-NIR two-photon excited CaF2:Tm3+,Yb3+ nanoparticles: multifunctional nanoprobes for highly penetrating fluorescence bio-imaging,” ACS Nano, 2011, 5(11), Pages 8665-71, DOI: 10.1021/nn202490m, the entire contents of which are hereby incorporated by reference in their entirety. On the basis of the strong Tm(III) ion emission (at around 800 nm), tissue penetration depths as large as 2 mm have been demonstrated, which is more than 4 times that of the visible emissions in comparable lanthanide-doped CaF₂ NPs. These NPs with great penetration depth, together with the fluorescence thermal sensitivity, are well suited as multifunctional nanoprobes for high-contrast and deep-penetrating in vivo imaging. See, Otto S. Wolfbeis.

Lipid NPs—like hydrogels NPs—are soft but highly apolar. They resemble hydrophobic dendrimers and can be easily prepared but often lack stability if placed in complex systems. See, Otto S. Wolfbeis. When deployed in vivo, NPs are typically protected from the immune system by coating them with poly(ethylene glycol) (PEG). See, Otto S. Wolfbeis. A wide variety of strategies are known to coat and characterize NPs with PEG. See, Jesse V. Jokerst, et al., “Nanoparticle PEGylation for imaging and therapy,” Nanomedicine (Lond), 2011, 6(4), Pages 715-28, DOI: 10.2217/nnm.11.19, the entire contents of which are hereby incorporated by reference in their entirety. The core materials differ strongly in terms of size, shape, density, loading level, molecular weight, charge and method for purification.

However, other hydrogels have been used that work as well. One group coated upconversion nanocrystals of the type NaYF4:Yb,Er with poly(vinyl pyrrolidone, and then a ligand exchange reaction was performed with polyethylenimine (PEI) and poly(acrylic acid). See, Jiefu Jin, et al., “Polymer-coated NaYF₄:Yb³⁺, Er³⁺ upconversion nanoparticles for charge-dependent cellular imaging,” ACS Nano, 2011, 5(10), Pages 7838-47, DOI: 10.1021/nn201896m, the entire contents of which are hereby incorporated by reference in their entirety. The coated UCPs can be dispersed in aqueous medium. The positively charged PEI-coated particles are readily taken up by cells. The long-term in vivo biodistribution of polyacrylic acid-coated upconversion nanophosphors was imaged by one group and their toxicity is low. See, Liqin Xiong, et al., “Long-term in vivo biodistribution imaging and toxicity of polyacrylic acid-coated upconversion nanophosphors,” B Biomaterials, 2010, 31(27), Pages 7078-85, DOI: 10.1016/j.biomaterials.2010.05.065, the entire contents of which are hereby incorporated by reference in their entirety.

UCPs are hydrophobic if prepared by common methods. In order to make them water-soluble, one group capped the surface of UCPs with a polymer by replacing the original oleate ligand by multidentate thiolate grafting. See, Marta Liras, et al., “Thin Amphiphilic Polymer-Capped Upconversion Nanoparticles: Enhanced Emission and Thermoresponsive Properties,” Chemistry of Materials (2014), 26(13), Pages 4014-4022, the entire contents of which are hereby incorporated by reference in their entirety. The side chains of the coating extended into the solution and rendered the UCPs water-dispersible. The resulting nanohybrids exhibited an emission brighter by a factor of 10 in organic solvent and by a factor of 2 even in water, and their fluorescence was highly thermoresponsive. See, Marta Liras.

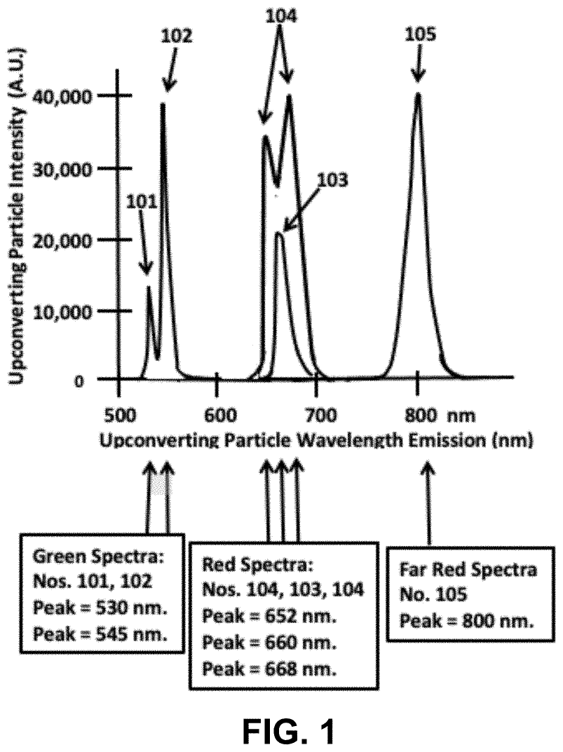

FIG. 1 depicts a graph depicting an effect of IR light irradiation (e.g., at 940 nm or 980 nm IR light) on UCPs, according to at least some embodiments disclosed herein. The graph plots intensity of visible light emissions in arbitrary units for three different UCPs as a function of the nanometer wavelength of the visible light emission spectra: (1) green light with a peak 101 at 530 nm and a peak 102 at 545 nm, (2) red light with a peak 103 at 660 nm and a peak 104 at 652 nm and 668 nm, and (3) a far-red light with a peak 105 at 800 nm.

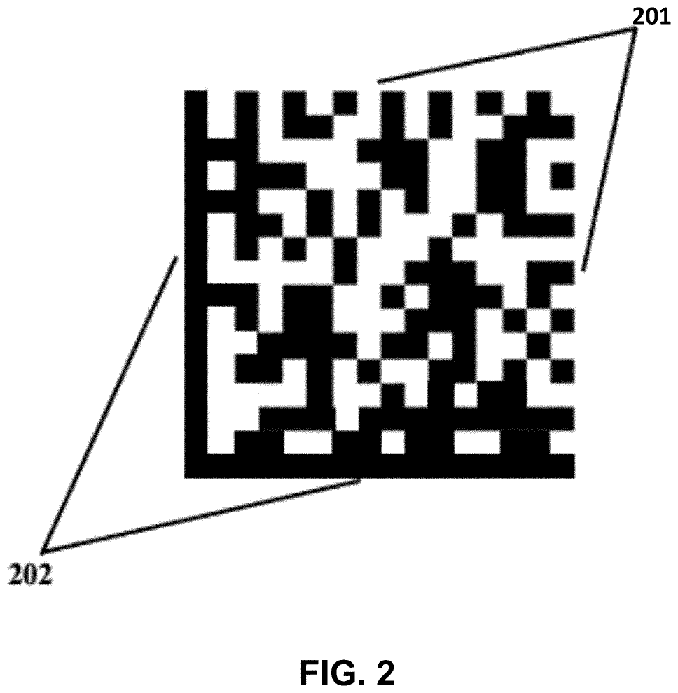

FIG. 2 depicts a schematic diagram and a top view of a 16×16 two-dimensional (2D) data matrix with random positioned black dots (black squares) and white dots (white squares), according to at least some embodiments disclosed herein.

In mathematics, a “binary number” can be a string of zeros and ones. A binary number can be another kind of binary using two different colored symbols, for example a color and a white, or a color and a black. Symbols can be imagines and processed by a processor in a two dimensional matrix, a three dimensional matrix, or an N-dimensional orthogonal matrix as useful in applications of linear algebra methods which has rows and columns to compact the binary numbers.

The dots depicted in some embodiments of the invention are useful in their number, randomness, positions, and patterns for conversion to a binary data matrix of binary symbolic elements created transiently in a volatile memory of a computing device by a processor. Preferably, the activities of the present invention for the production of a private key occur when the computing device is off-line (disconnected from the Internet) so as to be inaccessible by any Internet connection means, including WIFI, an optical feed, or satellite communication means or by another form of electronic communications, such as a telephone line using a modem.

It should be appreciated that, in FIG. 2, the dots are depicted as black square dots and white square dots. The dots may be any combination of different sized dots with the dot sizes used to add information for an optical scanner or data compression methods know in the prior art. For the present invention, some preferred embodiments use a device or an article of manufacture having dots, such as up-converting particles (UCPs) which can be invisible to a human eye until the UCP dots are irradiated by the IR light. As used herein, the term “a dot” includes a square dot, a round dot, an irregular shape dot, a dot of any shape or dot dimensions, a cell, a matrix dot, a point, an object such as a chess piece, different polygons, and wherein the dots have different sizes.

The dots are depicted in FIG. 2 as a random pattern in which the number of white squares is same number as or is not equal to the number of black squares with the dots having same dimensions, but in some embodiments the dots are conceived as having optical differences such, as different reflectivity to infrared light but not to visible light.

FIG. 2 also depicts a series of alternating black dots and white dots on a top side edge and a right side edge of the 2D data matrix of dots. This pattern of alternating dots can be used as an optical scanning timing pattern 201 on top and right edges of the 2D data matrix of dots for a mobile device scanner to scan and to send scan information to a processor of the mobile device to perform calculations of the size of the 2D data matrix in the mobile device volatile memory. The optical scanning of a data matrix may not be located and oriented parallel to the first row of the data matrix of dots.

FIG. 2 further depicts the 2D data matrix of dots having an optical scanning finder pattern 202 on the bottom edge and left edge of the 2D data matrix of dots for the mobile device scanner to scan and to send scan information to the processor to perform operations to locate and to orient row and column bits addresses in the mobile device volatile memory. It should be appreciated that the “optical scanning timing pattern method” includes counting the dark and white square repeats on a top and right side and then scanning time to calculate the data matrix 2D pixels. The “optical scanning finder pattern method” includes locating and orienting the data matrix scanning using left and bottom side wall line pixels.

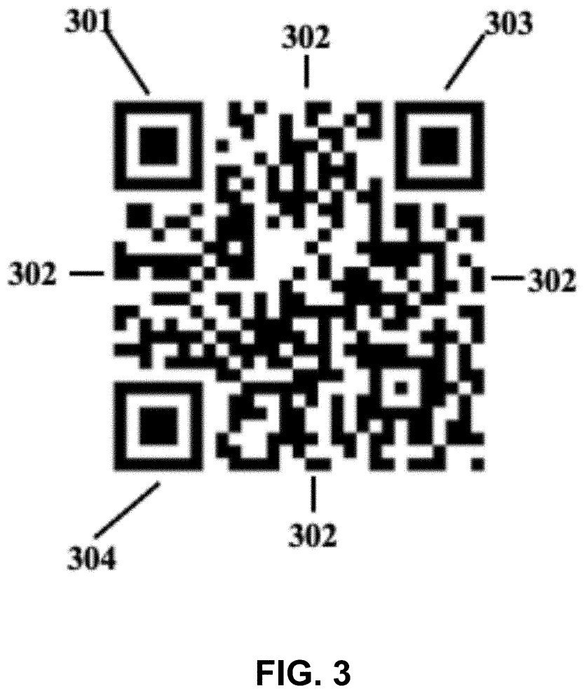

FIG. 3 depicts a schematic diagram and a top view of a 29×29 2D quick response (QR) code of dots with fiduciary marks 302 at an upper left apex 301, an upper right apex 303, and a lower left apex 304 of the QR code dots, according to at least some embodiments disclosed herein. Regarding QR code devices and patches known in the prior art, the Hara et al. U.S. Pat. No. 5,726,435 is relevant and is incorporated herein in its entirety. The Hara patent is useful in supporting the present specification with fundamental details that may be relevant under 35 U.S.C. 112 that satisfy some written description and enablement requirements of the present application. It is noted that Hara patent concerns QR code uses, error correction means for QR Code reading, effects of stains on QR code patches, QR code cell square in a QR Code Matrix, and various methods, systems, and apparatus for using QR Codes.

The fiduciary marks 302 at the upper left apex 301, the upper right apex 303, and the lower left apex 304 of the QR code dots of FIG. 3 enable the mobile device scanner to scan and to send scan information to a processor of mobile device to process for making a calculation of the size of the QR code dots in the mobile device volatile memory. The fiduciary marks 302 at the upper left apex 301, the upper right apex 303, and the lower left apex 304 of the QR code dots also enables the mobile device scanner to scan and to send scan information to the processor of the mobile device to process to locate and orient row, column addresses of the bits in the mobile device data matrix array, which is in memory, preferably a volatile memory of a mobile device practicing the present invention.

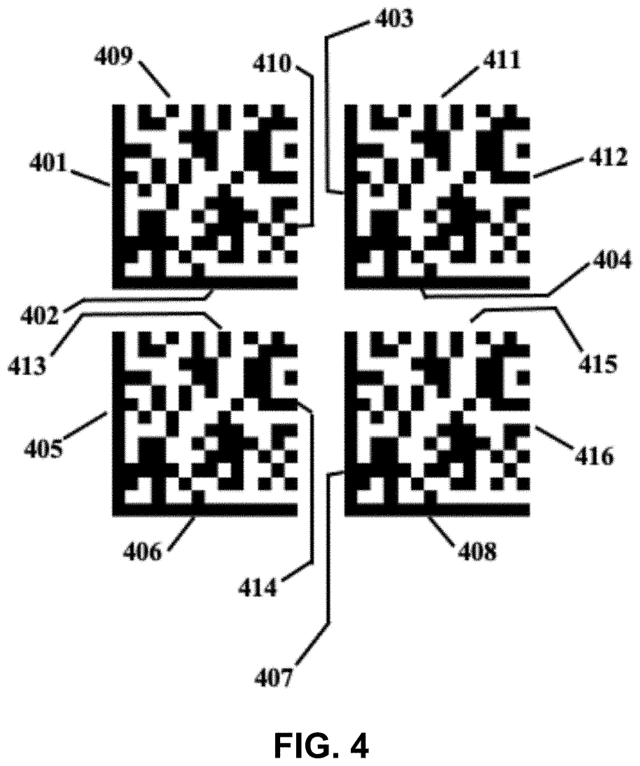

FIG. 4 depicts a schematic diagram and a top view of a square having four quadrants where each of the quadrants comprises a 16×16 2D data matrix of dots, according to at least some embodiments disclosed herein. In this example, the 2D data matrix of dots has four optical finder patterns having sides 401, 402, 403, 404, 405, 406, 407, and 408. Dot patterns in each quadrant's 16×16 data matrix of dots may be compared with dot patterns in the other three quadrants. The finder patterns are used to accomplish accurate scan of the dot patterns in each data matrix of dots.

It should be appreciated that the present invention may comprise any number of quadrants of data matrixes of dots. In examples, the size of a data matrix may be selected from the group consisting of 4-15 dots, 16 dots, 32 dots, 36 dots, 49 dots, 64 dots, 81 dots, 100 dots, 144 dots, 4-144 dots, or 4-256 dots, and any combination thereof. Such finder patterns individually or optionally are used as further detailed in the specification.

Furthermore, FIG. 4 depicts the 2D data matrix of dots having an optical scanning timing patterns 409, 410, 411, 412, 413, 414, 415, and 416. The timing patters facilitate the means for scanning by a mobile device scanner to accomplish scanning and sending scan information about the 16×16 two dimensional data matrix of dots to the processor to perform operations for locating and orienting row and column bits addresses of each dot of the 16×16 2D data matrixes of the dots needed in the mobile device volatile memory.

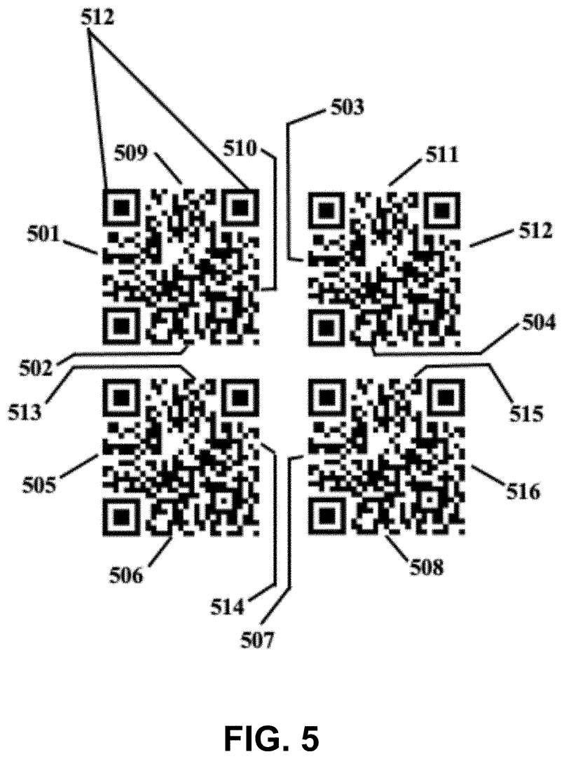

FIG. 5 depicts a schematic diagram and a top view of a square containing four quadrants with each quadrant comprising a 29×29 2D QR Code of dots, according to at least some embodiments disclosed herein. FIG. 5 also depicts fiduciary marks 512 at an upper left apex, the upper right apex, and the lower left apex of each the 29×29 QR code of dots. The upper left quadrant 29×29 QR code of dots has top edge fiduciary marks 512 and sides 501, 502, 509, and 510. The upper right quadrant 29×29 QR code of dots has sides 503, 504, 511, and 512. Further, the lower left quadrant 29×29 QR code of dots has sides 505, 506, 513, and 514. Moreover, the lower right quadrant 29×29 QR code of dots has sides 507, 508, 515, and 516.

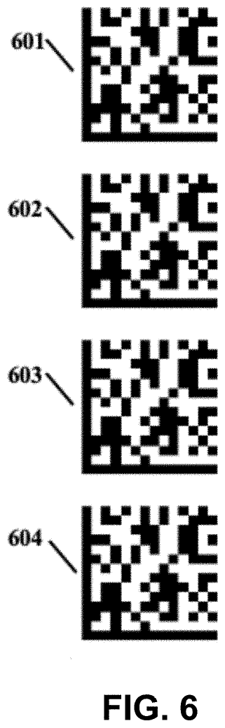

FIG. 6 depicts a schematic diagram of a strip containing a line having four quadrants 601, 602, 603, and 604, with each quadrant comprising a 16×16 2D data matrix of square dots, according to at least some embodiments disclosed herein.

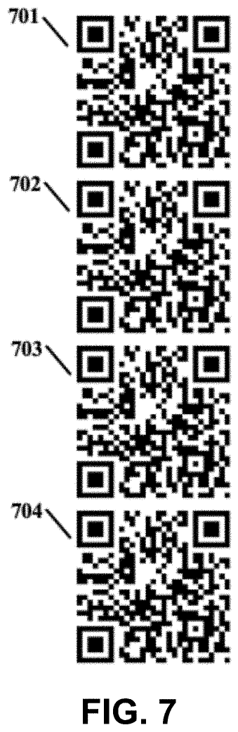

FIG. 7 depicts a schematic diagram and a top view of a strip containing a line having four quadrants 701, 702, 703, and 704, with each quadrant of the four quadrants 701, 702, 703, and 704 comprising a 29×29 2D QR code of square dots that are black and white, according to at least some embodiments disclosed herein. In a preferred embodiment, some of the dots may comprise a composition comprising UCPs, while some of the other dots may not contain up-converting dots.

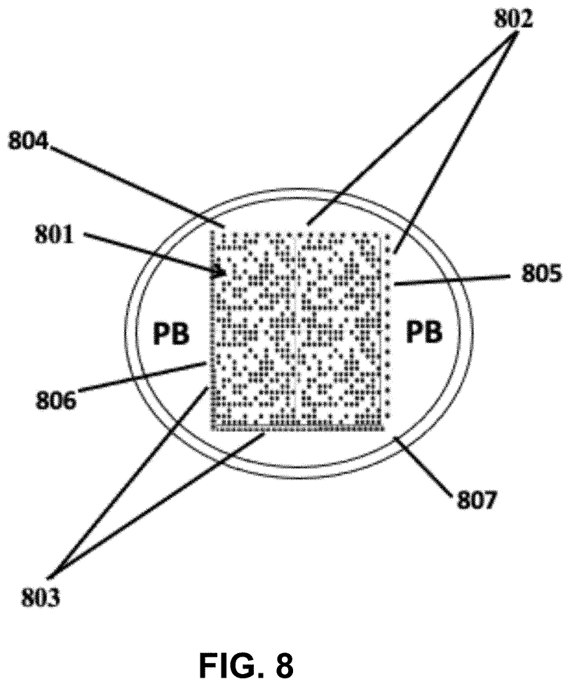

FIG. 8 depicts a schematic diagram and a top view of an oval patch comprising four closely positioned quadrants with each quadrant comprising a 16×16 data matrix and where the dots are depicted as a random dot pattern of black round dots 801 on a white background, according to at least some embodiments disclosed herein. The patch quadrants are labeled 804, 805, 806, and 807. The black dots form a continuous finder pattern line on the left edges of quadrants 804 and 806 and on the bottom edges of quadrants 806 and 807. The black dots have a timer pattern line on the left edges of quadrants 804 and 806 and on the bottom edges of quadrants 806 and 807. Further, FIG. 8 depicts a UCP alternating dots timing pattern 802 and a UCP continuous dots finder pattern 803. Moreover, FIG. 8 depicts a timer pattern line where centers of the black dots in the timer pattern line are a distance apart which is about twice the distance between centers of dots in the continuous finder pattern line.

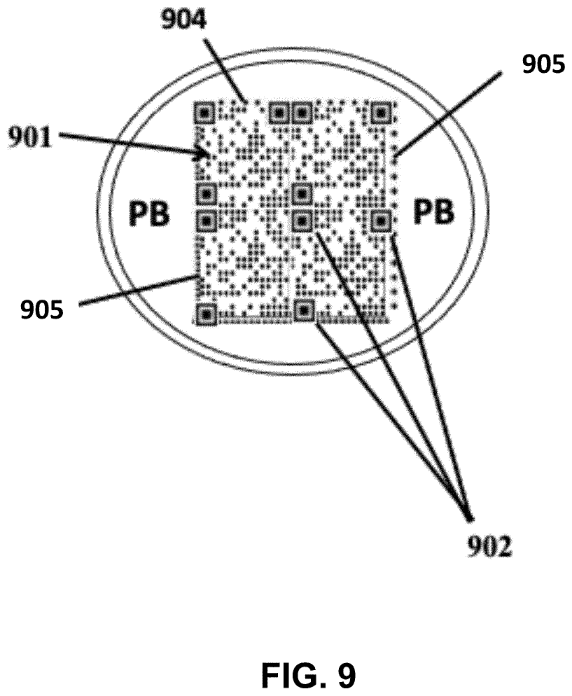

FIG. 9 depicts a schematic diagram of a square on an oval QR code patch comprising four closely positioned quadrants, with each quadrant comprising each a 16×16 data matrix of a random pattern of black dots 901 on a white patch background, according to at least some embodiments disclosed herein. The patch quadrants of FIG. 9 are labeled 904 and 905. In FIG. 9, the patch fiduciary marks (FMs) 902 are depicted using the same symbols as in FIG. 3, FIG. 5, and FIG. 7, and the FMs 802 are positioned in each 29×29 QR code of dots as depicted in FIG. 3, FIG. 5, and FIG. 7, with each quadrant comprising a 16×16 two dimensional QR code of dots.

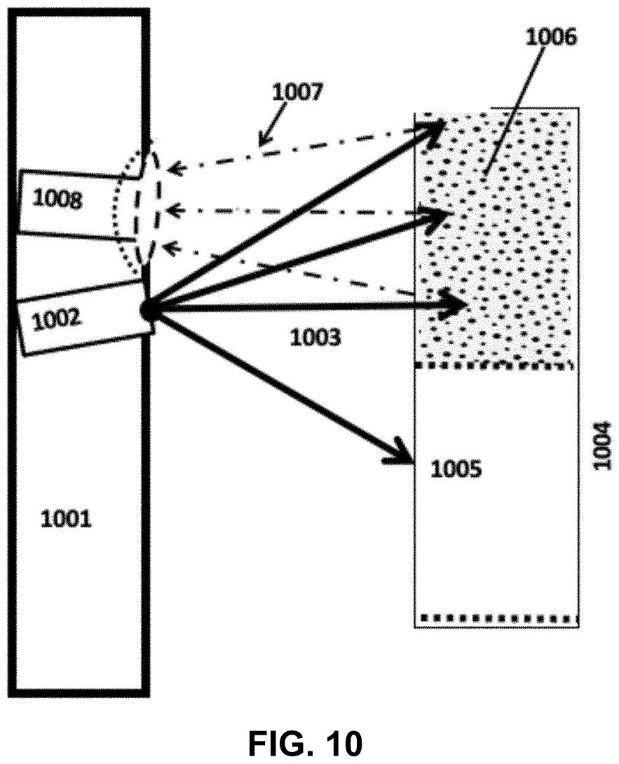

FIG. 10 provides a cross-sectional view of a highly simplified schematic depiction of a mobile phone 1001 separated by an air gap 1003 and with a cross-sectional view of a data matrix dot 1004 containing UCPs next to a data matrix dot 1005 that comprises a dot composition having no UCPs, according to at least some embodiments disclosed herein. The UCPs of the data matrix dot 1004 are depicted as dark specs within a medium to comprise a composition of UCPs and up-converting particles (UCPs).

A data matrix of dot(s) 1004 or a QR code of dots may be situated at a place selected from the group consisting of: a device, a computer location, on a surface, in a home, in a book, in an office, outdoors, on a person's body, on an animals body, on a person's skin, on clothing, on a painting, in a wallpaper, on a painted surface, on a tool, embedded in the skin of a human or animal, on an article of manufacture, on a user selected place, on a place which is hidden, on a place where the dots 1004 are invisible to a human eye, etc.. It should be appreciated that the examples of the locations where the data matrix of dot(s) 1004 or the QR code of dots may be situated is not limited to the examples provided herein, as such listing is for illustrative purposes only and is non-exhaustive.

The data matrix of dot(s) 1004 may comprise UCPs, which can be invisible to a human eye until the dots are irradiated by IR laser radiation 1002. The data matrix of dot(s) 1004 with the UCPs in FIG. 10 are exposed (being irradiated, being hit, shined upon, being excited, etc.) by one or more beams (solid arrows pointing to the data matrix of dot(s)) from an infrared light source, such as an IR laser 1003 of mobile phone 1001. FIG. 10 also depicts color light 1008 from a camera of the mobile phone 1001, the UCP dots emitting a visible light 1007, and the data matrix UCPs dot 1006.

In some examples, rather than using the mobile phone 1001, the device may be: a laptop computer, a desktop computer, a tablet computer, an eyeglasses computer, a wrist watch computer, another computer device, or a combination thereof. The IR light source of any kind may be separate from the mobile device (phone) 1001.

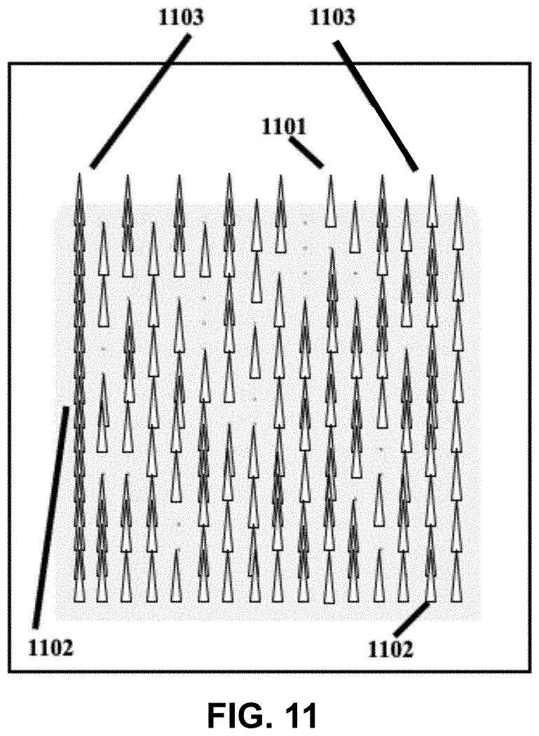

FIG. 11 depicts a schematic diagram and a biocode 16×16 data matrix of microneedles 1101 in a random pattern, where the microneedles contain UPCs, according to at least some embodiments disclosed herein. There is an alternate UCP dots line timing pattern 1103 and a line of UCP dots finder pattern 1102.

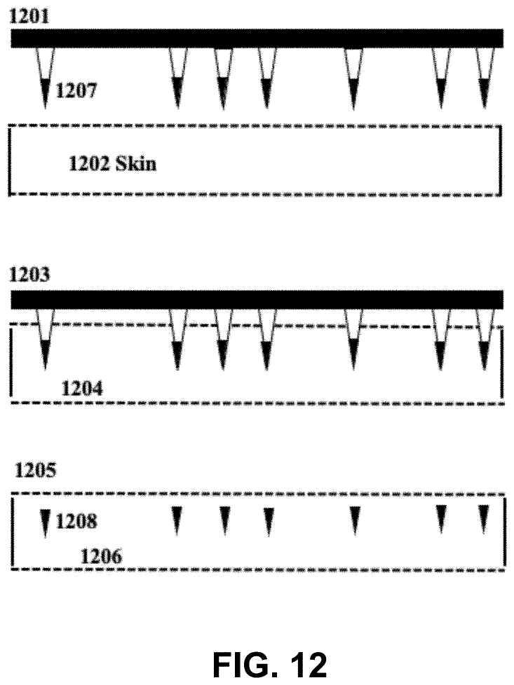

FIG. 12 depicts a cross-sectional view of a process involving UCP-tipped microneedles as part of a biocode data matrix, according to at least some embodiments disclosed herein. A first step of the process of FIG. 12 includes a patch 1201 of UCP-tipped microneedles 1207 being positioned over a selected region of a user's skin 1202 (or untouched epidermis-dermis). A second step of the process of FIG. 12 includes pushing the patch 1201 of the UCP-tipped microneedles 1203 into the skin 1202, which punctures the epidermis/dermis 1204 of the person. A third step of the process of FIG. 12 includes removing the patch 1201 of the UCP-tipped microneedles 1207 from the skin 1202, leaving the UCP tips of the microneedles embedded in the skin 1202. As such, the UCP's data matrix is now installed beneath a surface of the skin 1202. After healing, the epidermis/dermis 1206 contains the UCPs in a fixed pattern 1205 as a biocode matrix. In one embodiment, the UCP tipped microneedles 1208 dissolve after being inserted into the skin 1202, thereby leaving the UCPs in a fixed pattern in the skin 1202.

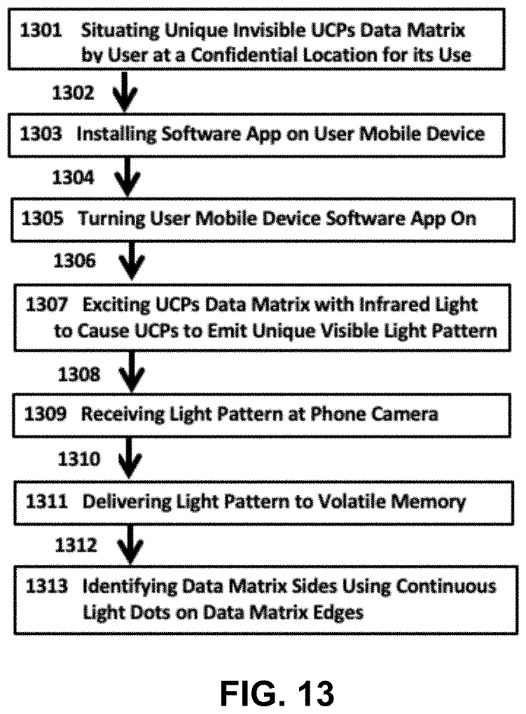

FIG. 13 depicts a block diagram of a method for acquiring a UCP data matrix information on a mobile device, according to at least some embodiments disclosed herein. A first process step 1301 of the method of FIG. 13 involves situating the UCPs data matrix at a particular location by a user. After execution 1302 of the process step 1301, a process step 1303 occurs. At the process step 1303, an application is installed on a mobile device (computer) for processing information of the UCPs data matrix. After execution 1304 of the process step 1303, a process step 1305 occurs. The process step 1305 involves activating the application on the mobile device (computer).

After execution 1306 of the process step 1305, a process step 1307 occurs. At the process step 1307, the UCPs data matrix is excited with IR light for causing the UCPs data matrix to emit a visible light data matrix pattern. After execution 1308 of the process step 1307, a process step 1309 occurs. At the process step 1309, a camera of the mobile device is used for receiving the visible light data matrix pattern.

After execution 1310 of the process step 1309, a process step 1311 occurs. At the process step 1311, the visible light data matrix pattern is delivered to a volatile memory in the mobile device. After execution 1312 of the process step 1311, a process step 1313 occurs. At the process step 1313, the data matrix sides are identified using continuous light dots present on the data matrix edges on the visible light data matrix pattern. The process step 1313 concludes the method of FIG. 13.

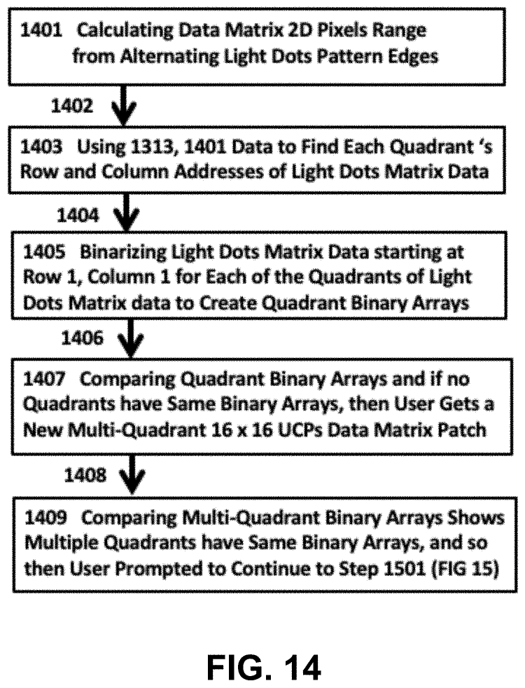

FIG. 14 depicts a block diagram of a method for binarizing data matrix quadrant light dots, according to at least some embodiments disclosed herein. The method of FIG. 14 begins at a process step 1401. At the process step 1401, a data matrix 2D pixels range is calculated from alternating light dots pattern edges of the data matrix. After execution 1402 of the process step 1401, a process step 1403 occurs. At the process step 1403, the method includes using data matrix sides information of the process step 1313 of FIG. 13 and alternating light dots pattern edges information 104 to find each quadrant's row and column address boundaries for the light dots matrix data.

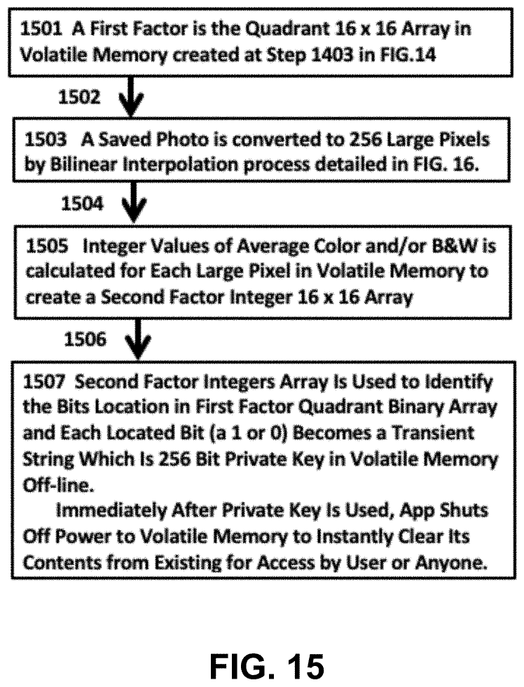

After execution 1404 of the process step 1403, a process step 1405 occurs. At the process step 1405, the method includes binarizing the light dots matrix data starting at row 1, column 1 for each of the quadrants of light dots matrix data so as to create each quadrant's light dots matrix data as a binary array. After execution 1406 of the process step 1405, a process step 1407 occurs. At the process step 1407, the method includes comparing a congruency of each of the quadrant binary arrays. If a multiple of the quadrants fails to have identical binary arrays, then the method includes providing the user with a replacement multi-quadrant 16×16 UCPs data matrix patch. After execution 1408 of the process step 1407, a process step 1409 occurs. At the process step 1409, the method includes prompting the user to continue to method step 1501 of FIG. 15 in response to determining that three to four of the quadrant binary arrays have identical binary arrays. The process step 1409 concludes the process of FIG. 14.

FIG. 15 depicts a block diagram of a method for using binary array information in a volatile memory of a mobile device which was obtained from the process step 1311's UCPs light pattern detected by the mobile device camera, according to at least some embodiments disclosed herein. The method of FIG. 15 involves using an internal second factor array for instructing how to step through the binarized array information in the volatile memory of the mobile device, which has been obtained from the process step 1311's UCPs light pattern detected by the mobile device camera. The method of using the internal second factor array creates a private key from how the sequence of the binarized array information has been stepped through.

The method of FIG. 15 begins at a process step 1501, as referenced in FIG. 14. At the process step 1501, the method of FIG. 15 includes using a first factor (which is using one or more of the quadrants of the 16×16 external data matrices), which is being stored in the volatile memory. After execution 1502 of the process step 1501, a process step 1503 occurs. At the process step 1503, the method of FIG. 15 includes converting a specific user-selected photograph stored on the mobile device to a 256 pixel image by a bilinear interpolation process. After execution 1504 of the process step 1503, a process step 1505 occurs. At the process step 1505, the method includes calculating an integer value for each of the 256 pixels, which is an average color with or without black and white data from the pixels. The integer average color for each of the 256 pixels is stored is stored in the volatile memory as a step towards creating the second factor array in the volatile memory.

After execution 1506 of the process step 1505, a process step 1507 occurs. At the process step 1507, the method of FIG. 15 includes using the second factor array average color integers for instructing which locations in the binarized array information in the volatile memory of the mobile device, which sequentially are being used to create the private key in the volatile memory. In addition, at the process step 1507, one embodiment of the invention involves erasing the private key by turning off power to the volatile memory to instantly erase the private key from the volatile memory. The process step 1507 concludes the method of FIG. 15.

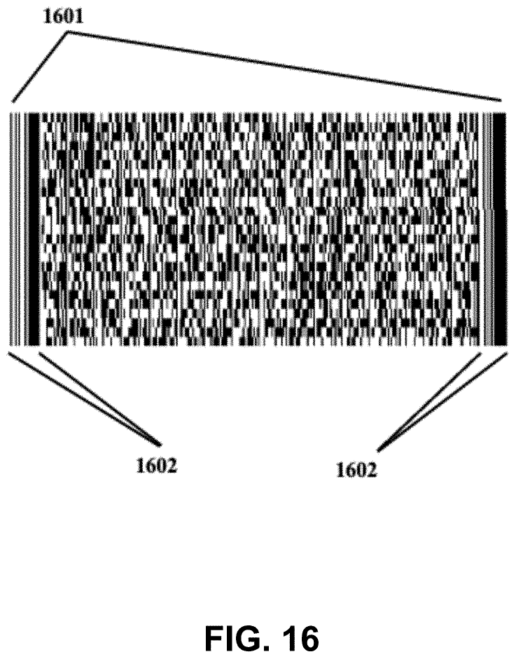

FIG. 16 depicts a schematic diagram of a 25 rows×400 columns rectangular data matrix 1601 with left-side finder patterns and right-side finder patterns 1602, according to at least some embodiments disclosed herein.

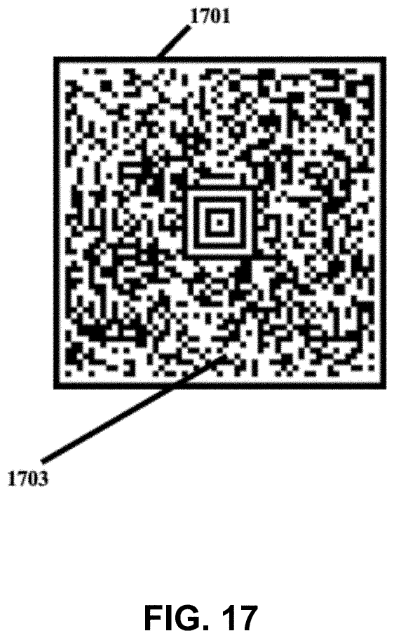

FIG. 17 depicts a schematic diagram of an Aztec 53×53 dots matrix 1701 with a center fiduciary mark and UCPs dots data 1703 arranged in a spiral pattern around the center fiduciary, according to at least some embodiments disclosed herein.

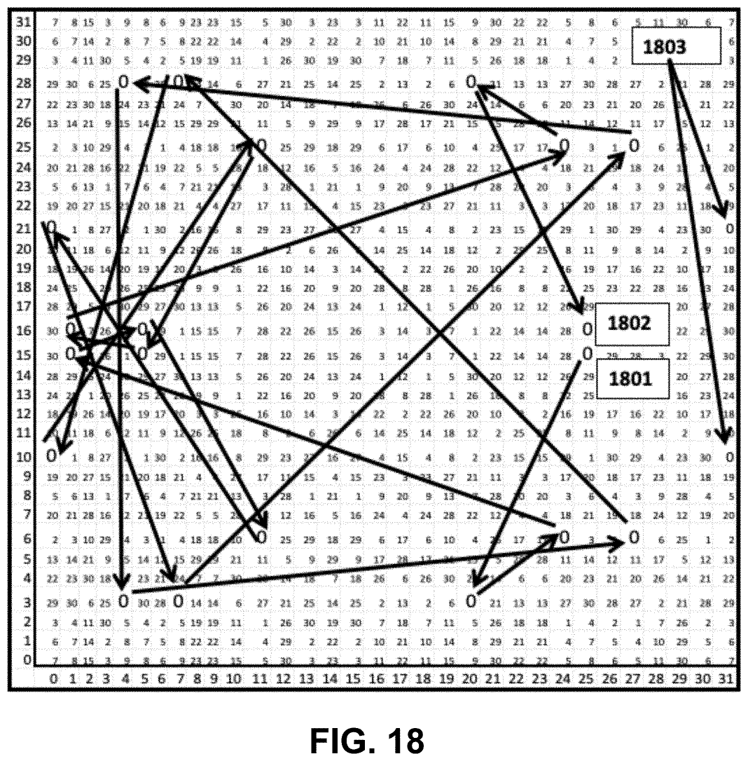

FIG. 18 depicts a schematic diagram of a finite modulo square small array table, according to at least some embodiments disclosed herein. As shown in FIG. 18, a range x is 0 to 31 and a range of y is 0 to 31, such that there are 32∴32=1,024 (x,y) coordinates. Each of the 1,024 (x,y) coordinates in the finite modulo square array table of FIG. 18 has a calculated whole number N equal to N=(x³-y²)+7, where the value of x and the value of y used in the calculation are the (x,y) coordinate values. Only twenty-two of the calculated numbers for the 1,024 (x,y) coordinates have a calculated value of zero. There are two excess zero numbers 1803 calculated at (x,y) coordinates (31,10) and (31,21), as depicted in FIG. 18, as excluded because the ECC rules limit the mathematic operations in this modulo case the number of (x,y) coordinated used to 20.

From an (x,y) coordinate value of zero at a start point 1801, a first scalar arrow is situated in the table. As the ECC mathematics is performed using this table, there are sequential scalar arrows placed on the table between consecutive (x,y) coordinates equal to zero. There are a total of 20 scalar arrows multiplication steps as the multiplication steps, which end at an end point 1802. Moreover, a Generator Point is multiplied (using modular arithmetic) by 1-20 and produces the 20 points depicted with arrows. The symmetry with respect to Y=15.5 is evident in the array.

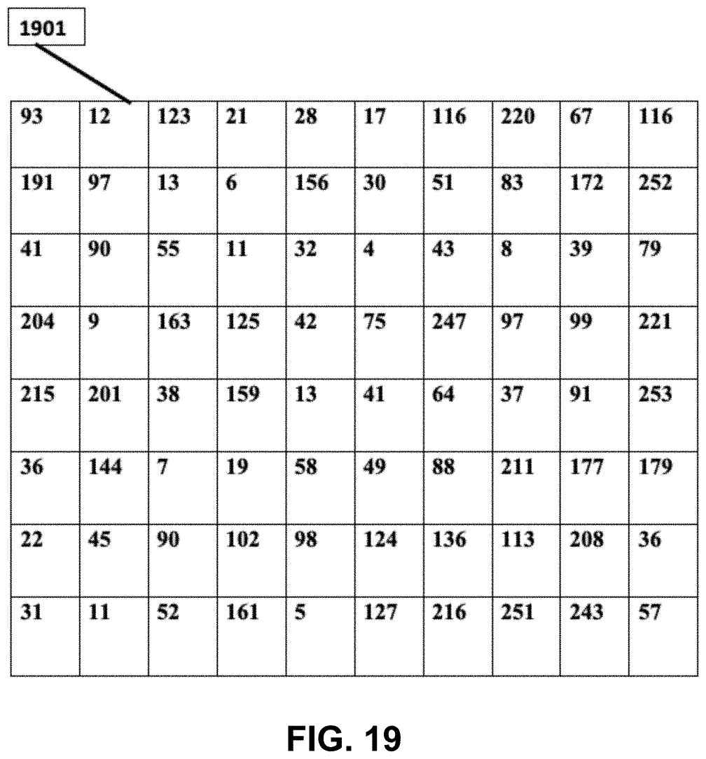

FIG. 19 depicts a schematic diagram of a second factor array process used in a method for creating a private key, according to at least some embodiments disclosed herein. FIG. 19 depicts a simplified second factor array which is only 10×10 pixels. During actual use and in preferred embodiments, the second factor array is be 16×16 second factor array of pixels. Each of the pixels depicted in the FIG. 19 10×10 pixels second factor array is an integer (rounded) value calculated from the red, green, and blue pixel values (range 1-256). Moreover, as shown, the second factor array 1901 with average color of each pixel is 10×8. The second factor array process for private key includes saving mobile phone color pictures pixelized to 80 pixels, with the pixel mean color being: (pixel red+pixel green+pixel blue)/3, and rounded to an integer, which identifies which cell address bits in external data matrix are read to form private key.

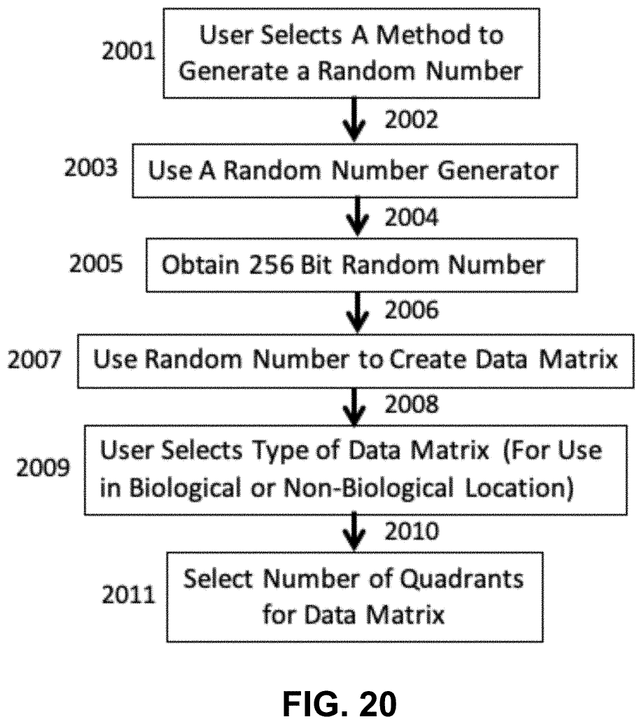

FIG. 20 depicts a block diagram of a method for generating a quantum random number, according to at least some embodiments disclosed herein. The method of FIG. 20 begins at a process step 2001, where the process includes selecting a method for generating a random number. After execution 2002 of the process step 2001, a process step 2003 occurs. At the process step 2003, the method includes using a random number generator for obtaining a 256 bit random number 2005. The 256 bit random number 2005 is achieved after execution 2004 of the process step 2003. The 256 bit random number 2005 is processed at a process step 2006. At a process step 2007, the 256 bit random number 2005 is used to create a data matrix (e.g., a 16×16 random binary data matrix of ones and zeroes—binary dots of colors, black and/or white). It should be appreciated that the binary dots may be based on colors emitted by the UCPs or printed colors on the binary data matrix device.

After execution 2008 of the process step 2007, a process step 2009 occurs. At the process step 2009, the method includes the user selecting a type of data matrix and a location where the user intends to locate the data matrix (e.g., a biological location or a non-biological location). After execution 2010 of the process step 2009, a process step 2011 occurs. At the process step 2011, the method includes selecting the number of quadrants, which will be provided for the data matrix device (e.g., a functional article of manufacture). The process step 2011 ends the method of FIG. 20.

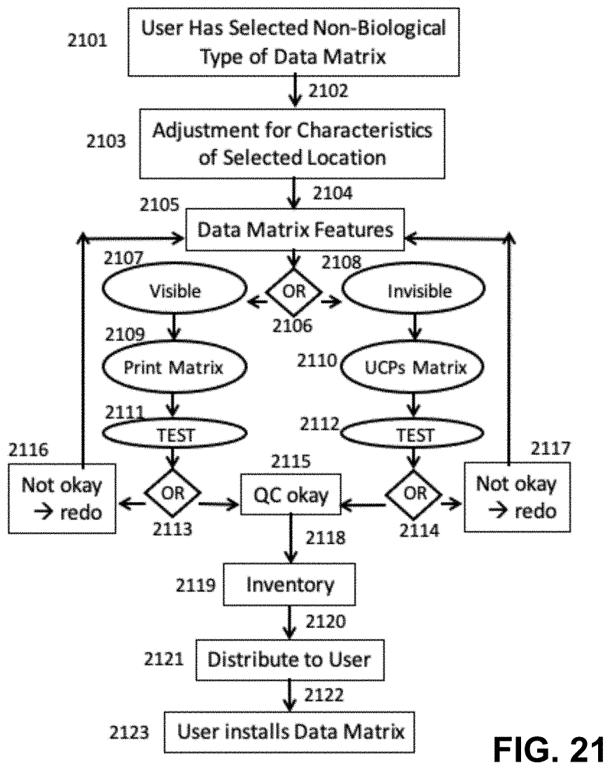

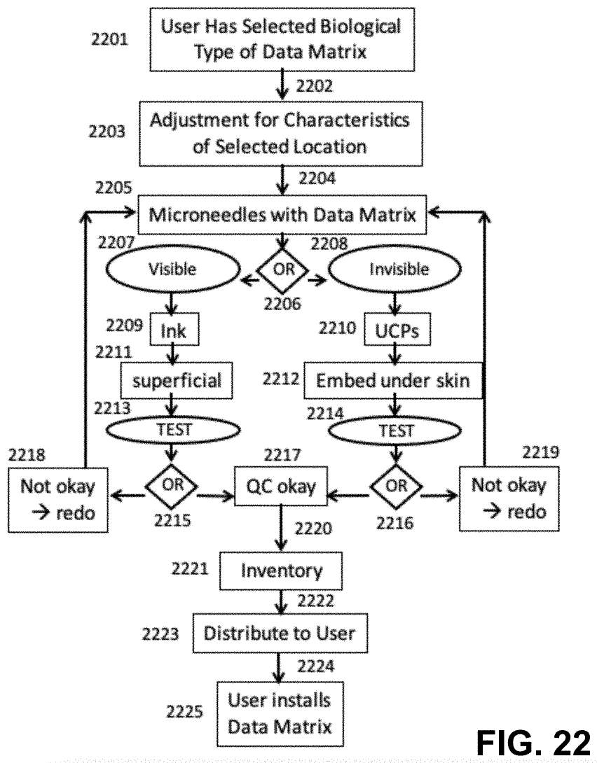

FIG. 21 depicts a block diagram of a highly schematic algorithm for selecting and manufacturing a data matrix patch for a non-biological location, according to at least some embodiments disclosed herein. FIG. 22 depicts a block diagram of a highly schematic algorithm for selecting and manufacturing a data matrix patch for a biological location, according to at least some embodiments disclosed herein.

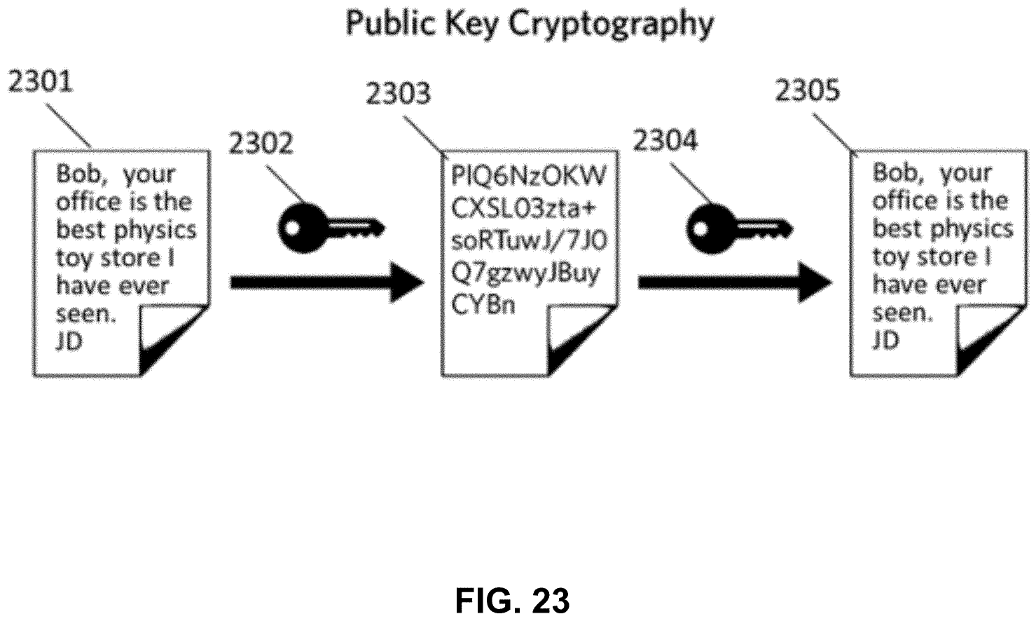

FIG. 23 depicts a schematic diagram of a simple public key cryptography used with a public key 2302 to encrypt a short plaintext document 2301 as a means for creating a ciphertext document 2303, and then using a unique related private key 2304 to decrypt the ciphertext document 2303 back to the original plaintext 2305, according to at least some embodiments disclosed herein. The public key and the private key are each different and unique and needed to perform the cryptography mathematics for reversible conversions of plaintext to ciphertext.

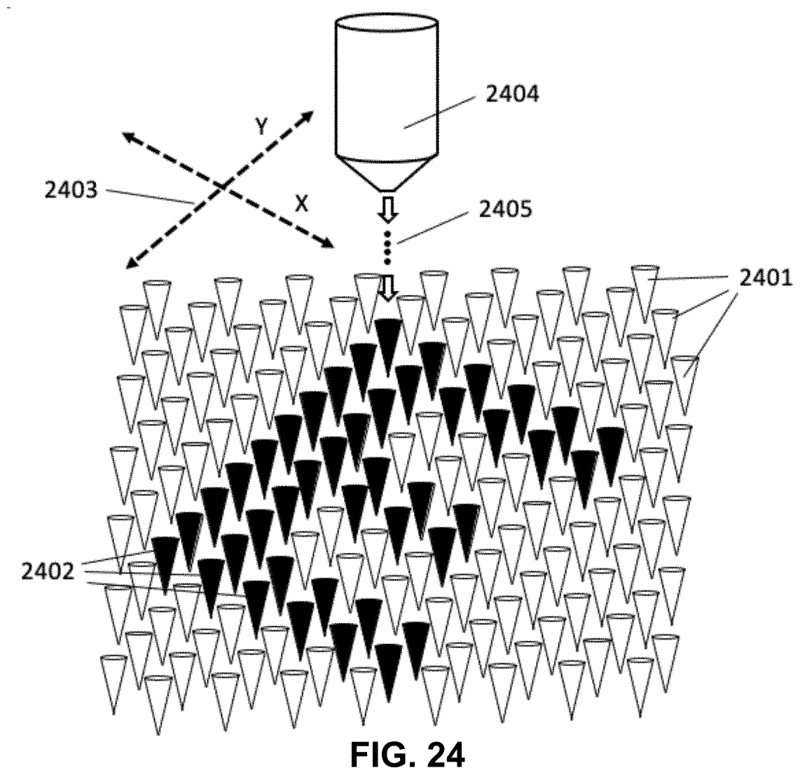

FIG. 24 depicts a schematic diagram of a method of filling an inverted array (with openings up) of initially unfilled microneedles 2401 (depicted as transparent) in a shape of a letter “E” arranged along a grid in x and y directions 2403, according to at least some embodiments disclosed herein. An ink jet type unit 2404 may be used to dispense fluid droplets 2405 comprising UCPs into individual unfilled microneedles 2401 to turn individual unfilled microneedles 2401 into filled microneedles 2402 by moving relative to each other either the dispenser or the microneedle patch according to a pre-programmed pattern along the x and y directions 2403. Any pattern or coordinate system can be used to position individual microneedles locations and their filling, including random number-generated patterns.

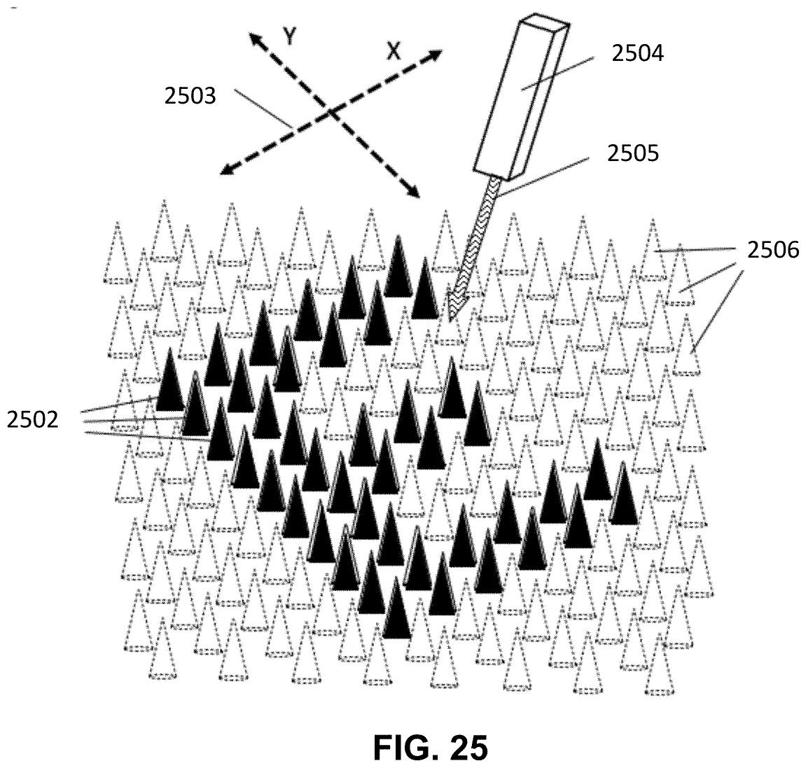

FIG. 25 depicts a schematic diagram of an array of filled microneedles 2502 (e.g., black), according to at least some embodiments disclosed herein. A coordinate system 2503 is used to guide a laser type unit 2504, which generates a beam 2505 that ablates or empties individual UCP-filled microneedles 2502 to generate a pattern of missing individual microneedles 2506 (transparent with dashed line). Any pattern or coordinate system can be used to ablate or empty individual microneedle locations, including randomly generated patterns.

As an example, a pattern in the shape of the letter “E” of filled microneedles 2502 (black) has been created by the laser type unit 2504 with a beam 2505 and moving along a coordinate system 2503. Missing, ablated or emptied individual microneedles are shown as 2506 (transparent with dashed line). Any pattern or coordinate system can be used to ablate or empty individual microneedle locations, including randomly generated patterns.

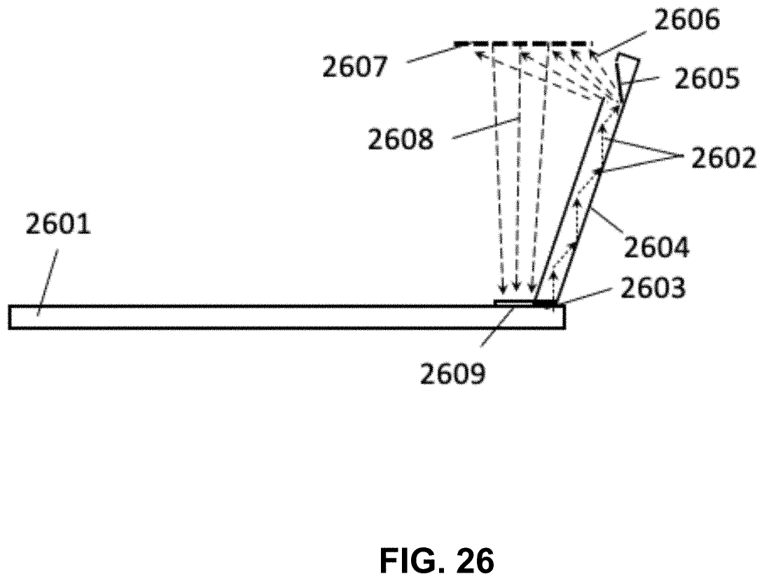

FIG. 26 depicts a schematic diagram of a mobile device or a smartphone 2601, when viewed from a side, of an light emitting diode (LED) or a vertical-cavity surface-emitting laser (VCSEL) emitter 2603 that is emitting IR or visible excitation light 2602 from a surface of the mobile device or the smartphone 2601, according to at least some embodiments disclosed herein. The excitation light 2602 is captured by light guide 2604 and reflected internally on the inside walls of the light guide 2604 until hitting and being redirected by angled mirror 2605 before exiting light guide 2604 as beams 2606 with the beams illuminating the external data matrix (device) 2607. The angled orientation of light guide 2604 with respect to the direction of imaging 2608 provides a clear field of view for the detection of the external data matrix 2607. The user is informed by a cue from the smartphone 2601 such as a sound, flash or vibration that the external data matrix 2607 has been successfully read by the smartphone UCP emission light detector 2609.

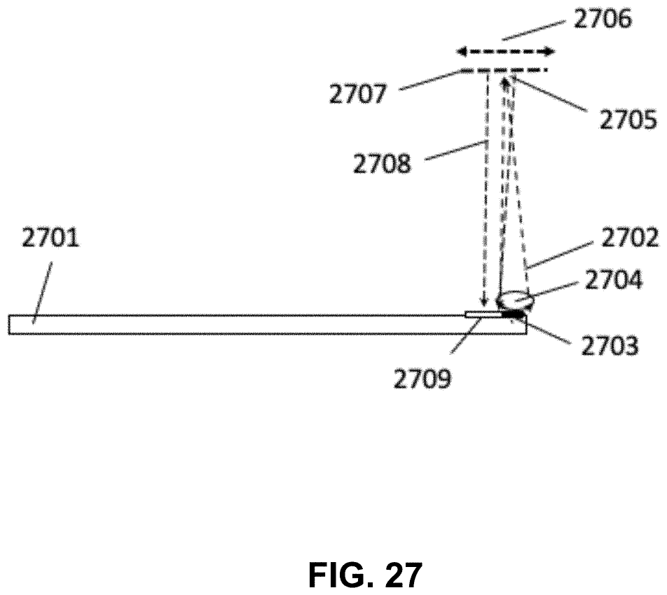

FIG. 27 depicts a schematic diagram of a side-view of a mobile device or a smartphone 2701 performing a line scan of an external data matrix 2707 using IR or visible excitation light 2702 emitted from the mobile device or the smartphone LED or VCSEL emitter 2703, according to at least some embodiments disclosed herein. The excitation light 2702 is focused by a cylindrically or oval-shaped lens 2704, shown in cross section, to create a line 2705, shown in cross section, which illuminates the external data matrix 2707. The line of excitation light 2705 is used to scan according to orientation 2706 over the external data matrix 2707.

The relative motion between the line of excitation light 2705 and the external data matrix 2707 for achieving the line scan can be done by the user moving the mobile device or the smartphone 2701 in the direction indicated by 2706, done by an internal apparatus of the mobile device or the smartphone 270, or by an optional excitation attachment, which is attached to the mobile device or the smartphone 270 to do this line scan in direction 2706 using line of excitation light 2705, as a means for moving the illuminated line of excitation light 2705 of the line scan across the external data matrix 2707 in the direction indicated in 2706. The line scan method is continuously performed until the user is informed by a cue from the smartphone 2701 such as a sound, flash or vibration that the external data matrix 2707 has been successfully read by the smartphone UCP emission light detector 2709. The angled orientation of light guide with respect to the direction of imaging 2708 provides a clear field of view for the detection of the external data matrix 2707.

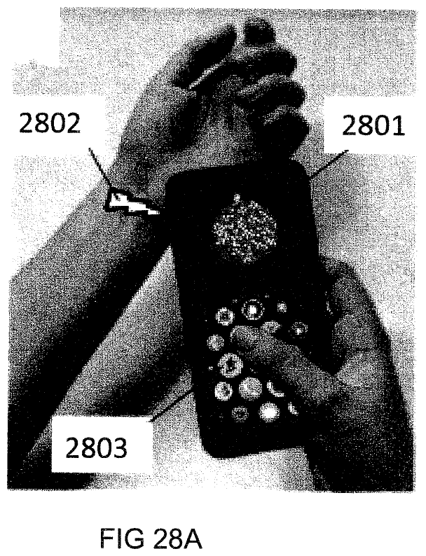

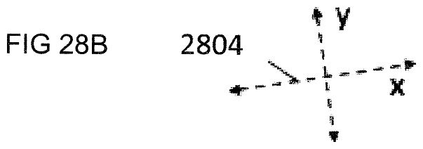

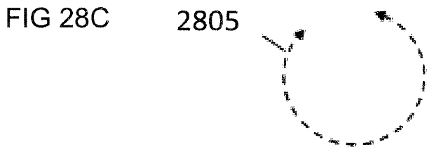

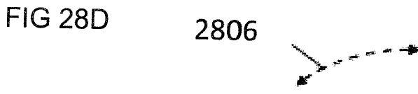

FIG. 28A depicts a schematic diagram of a mobile device or a smartphone that is pointed at a wrist of a user with an electromagnetic excitation directed at a location of an external data matrix and a list of application icons displayed on a screen of the mobile device or the smartphone, according to at least some embodiments disclosed herein. As shown in FIG. 28A, a smartphone 2801 is depicted in a person's right hand and is pointed at her left wrist with an electromagnetic excitation 2802 (such as white excitation light from flash LED or IR light from a VCSEL) directed at the location of an external data matrix and a list of application icons 2803 displayed on a screen of the smartphone 2801.

Relative motion of the smartphone 2801 (here detected by image processing, but alternatively also detected by other means, such as a magnetic field detector or inertia sensor) is used to scroll through the list of application icons 2803 without another type of user input and thereby allowing the display and selection of the desired application through its icon. The actual selection can then be completed by a simple touch or other type of user input, such as tapping or a voice command, and without the user having to use a touch and movement of the finger on the screen to scroll the icons.

FIG. 28B depicts a schematic diagram of a transverse motion 2804 (in the x and y direction of the smartphone's dimensions) that can be used to scroll through a list or grid display of icons, according to at least some embodiments disclosed herein. FIG. 28C depicts a schematic diagram of a rotational motion 2805 within the smartphone's image plane (around an axis perpendicular to the smartphone's dimension) that can be used to scroll through a list or grid display of icons, according to at least some embodiments disclosed herein. FIG. 28D depicts a schematic diagram of a tilting motion 2806 around an axis aligned with the smartphone's longest (vertical) dimension that can be used to scroll through a list or grid display of icons, according to at least some embodiments disclosed herein.

The selection can also be part of an endless loop of displayed applications. Once the end of a row or column is reached, the display reverses back to the applications that have first been displayed in the first row or column. Then a continuous rotation, tilting or translation of the smartphone 2801 results in a continuous looping through the same number of applications that are presented on the smartphone 2801. A physical equivalent of this operation would be to take sheet of paper that contains a grid with icons of apps and then bending the paper into a tube, so that rotation of the tube around its axis of symmetry continues to display the same recurring list of apps, even though the rotation is always carried out in the same direction.

Another way to select an application is to tilt the smartphone 2801 at a certain angle and let the list of applications move through the screen at a certain speed which is controlled by the angle. The impression for the user is as if the applications are ‘flowing downhill’ on the slope of the tilted smartphone 2801 screen. The equivalent of selecting an application then becomes the equivalent of ‘balancing’ an icon in the center of the screen by holding the smartphone 2801 horizontally (or in its initial orientation, if that was not horizontal).

When the desired application appears during selection process that is triggered by tilting the smartphone 2801, the user interrupts the process (stops the continuous scrolling of icons) by leveling out the smartphone 2801 and then fine tuning the selection of icons to the one that she desires to activate. The tilting motion preferably increases the speed with which the icons move over the screen with increasing tilt angles, whereas the translation speed reduces back to zero when the smartphone is leveled out again or brought back to its initial orientation when the app selection process was started.

The same effect can be achieved by a rotational motion of the smartphone 2801, where an increased angle of rotation with respect to a certain starting angle increases the speed by which the applications are presented. A return to an initial zero angle start position likewise can stop the scrolling of the application icons across screen so that the desired outcome can be selected. This motion of the application icons over the smartphone 2801 screen is preferentially correlated to the speed of the scrolling in a dependency that can be selected in the settings by the user. For instance, a linear setting would produce a linear increase in the scrolling speed based on the chosen angle of tilt or rotation. An exponential curve dependency would require a relatively large initial rotation in order to start the scrolling motion of the applications, where the scrolling speed progressively increases in a nonlinear fashion when the angle of the tilting or rotation of the smartphone is further increased with respect to the starting angle or starting position. This dependency provides a significantly greater control to the user for conveniently selecting the application icon of interest when being in the vicinity of the icon of interest, whereas providing a greater speed of traversing through the list of icons when the desired icon is not yet anywhere near the selection point in the array of displayed app icons.

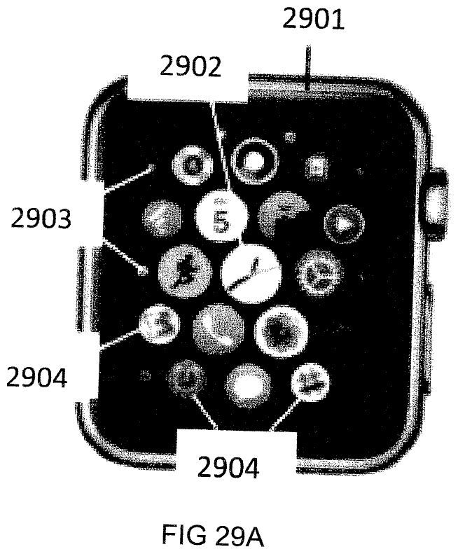

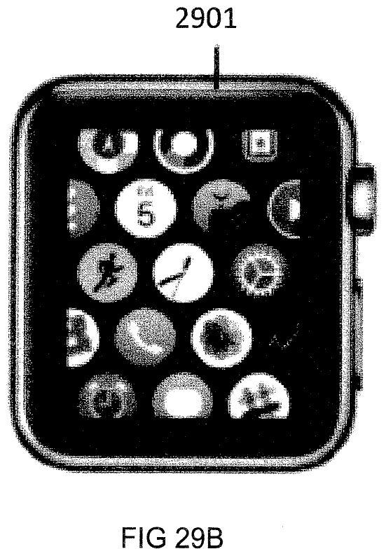

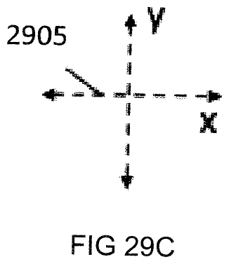

FIG. 29A depicts a schematic diagram of an array of displayed application icons on a mobile device, a smartphone, or a smartwatch 2901 that are of different sizes depending on their location on the screen, indicating a non-linear dependency of scrolling with respect to transverse movement, rotation, tilting by the user. For example, the icon in the center 2902 is largest, while icons on the periphery 2903 are smallest, and icons located slightly off-center 2904 are of intermediate size.

FIG. 29B depicts a schematic diagram of an array of displayed application icons on a mobile device, a smartphone, or a smartwatch 2901 that are all of equal size, indicating a linear dependency of scrolling with respect to transverse movement, rotation, tilting by the user, according to at least some embodiments disclosed herein. FIG. 29C depicts a schematic diagram of a transverse motion 2905 (in the x and y direction of the mobile device or the smartphone's dimensions) that can be used to scroll through a list or grid display of icons, according to at least some embodiments disclosed herein.

As an example of an exponential or otherwise non-linear curve dependency, an initial tilting or rotation of the smartphone of five degrees (with respect to an optical, magnetic or inertial reference as mentioned above) might produce a continuous scrolling motion of 1 millimeters per second, a tilting or rotation of 10 degrees might generate a motion of 3 millimeters per second, a rotation of 15 degrees might generate a motion of 9 millimeters per second, and a rotation of 20 degrees might generate a motion of 20 millimeters per second. Doing so provides greatly improved control over the App selection process and therefore a more convenient user experience. The type of dependency including the specific parameters of this dependency response curve can be made user controllable and selectable through the smartphone settings.

Another way to simplify the selection of an application is a virtual zoom feature, where the application currently tagged as active by the user (as selected by any of the procedures described above or by manual touch input) is enlarged and therefore easier to see and select.

Moreover, the instant invention also describes a method to achieve zero-knowledge identity and access management (ZIAM). The term “zero knowledge” refers to a “zero-knowledge proof,” which, in cryptography, is a method by which one party (the prover) can prove to another party (the verifier) that they know a value x, by only conveying that they know the value x. The essence of zero-knowledge proofs is that it is trivial to prove that one possesses knowledge of certain information by simply revealing it. The challenge is to prove such possession without revealing the information itself or any additional information. If proving a statement requires that the prover possesses some secret information, then the verifier will not be able to prove the statement to anyone else without possessing the secret information. The statement being proved must include the assertion that the prover has such knowledge, but not the knowledge itself. Otherwise, the statement would not be proved in zero-knowledge because it provides the verifier with additional information about the statement by the end of the protocol. Zero-knowledge proof may be interactive or non-interactive.

The present invention employs the bitcoin version of elliptic curve cryptography (ECC) to uniquely encrypt a tokenized URL at a single point in a 10⁷⁷×10⁷⁷ two-dimensional array. The term “tokenization,” when applied to data security, refers to a process of substituting a sensitive data element with a non-sensitive equivalent, referred to as a token, that has no extrinsic or exploitable meaning or value. The token is a reference (i.e. identifier) that maps back to the sensitive data through a tokenization system.

An example of a small ECC square (32×32) is shown in FIG. 18. It should be appreciated that this array is a mathematical construct and has nothing to do with the physical array (data matrix dots of the biocode patch) described in FIG. 1-FIG. 16. As depicted in FIG. 18, the X and Y coordinates of every point are integers. The 32×32 square array (of FIG. 18) produces only 20 valid points.

The term tokenized URL means that the uniform resource locator (URL) to a cloud server is appended with a random string, provided to the user by the cloud service, which when launched in a browser, gives the user immediate access without further disclosing credentials (such as username and password). Therefore, if stolen, a tokenized URL can give an unauthorized person access. The coordinates of the URL embedded point are both unknown and unknowable without the ECC 256-bit private key called the biocode which itself is unknown and unknowable. By unknown, we mean that no person, persons or organization knows the biocode nor is it stored on any device. In addition, there is no process or computation that can derive the ECC point coordinates or the biocode.

In one embodiment, the dots of a data matrix (FIG. 21 and FIG. 22) via a random number generator 2003 of FIG. 20 are generated through the use of a natural process that is inherently random, such as the decay over time of a radioactive isotope 2001 of FIG. 20, which is turned into a random, linear string of 1s and 0s, such as a 256 bit random number 2005 (of FIG. 20). The random linear string of bits is then converted into the two-dimensional dot array of the data matrix 2007. Use of an inherently random process enforces maximum entropy (randomness) in the resulting data matrix.

In another embodiment, individual photons of a highly diluted (weak) light source are detected by a single photon detector over time, and the output of the single photon detector is used as the random number generator 2003 of FIG. 20 to generate the 2D dot array of the data matrix. In one embodiment, a detector that is part of the smartphone is used for this purpose. In another embodiment, an external device attached to the smartphone is used for this purpose. In another embodiment, sound is detected and counted when it exceeds a certain, user-adjustable threshold. The resulting output is then used as the random number generator 2003 of FIG. 20 to generate the 2D dot array of the data matrix. The detected sound is preferably of a highly random nature, such as white noise, or noise from a natural environmental source, such as animals (frogs squawking, birds chirping) or plants (leaves rustling). In one embodiment, a microphone that is part of the smartphone is used for this purpose. In another embodiment, an external device attached to the smartphone is used for this purpose.

In another embodiment, an image of an inherently random process or event is used to generate the 2D random dot array. Examples of random events depicted by an image are well known and may comprise: a starry night, a collection of individual rain drops on a surface or photographed while falling, grains of sand or other objects on a surface, flowers on a field, leaves on a tree or on the ground, craters on the moon, bubbles in a cooking pot, spots on a windshield, hairs on a part of skin, etc.

In one example, the random linear string of bits is turned into the 2D dot array of the data matrix by allocating the bits in a row-by row path until the desired array of dots is fully filled with random bits originating from the random process used in the random number generator 2003 of FIG. 20. In another example, the random linear string of bits is turned into the 2D dot array of the data matrix by allocation of the bits in a zig-zag or spiral path.

As described, the data matrix is constructed in FIG. 20. In one embodiment, the data matrix is installed on a patch used in a non-biological location (of FIG. 21). Another embodiment, the data matrix is installed by the user in vivo (e.g., a biological location of FIG. 22). The microneedle array described herein can include visible (ink) or an invisible insertion of a corresponding array of up-conversion particles (UCPs). The data matrix is read by a mobile phone application which causes the array to emit visible light when irradiated by an IR laser as described in FIG. 15, FIG. 19, and FIG. 20. The mobile phone application can automatically read the array, transform it through a second factor photograph (of FIG. 19), to determine the biocode and then decrypts the URL. The tokenized URL is then launched in a browser and gives the user immediate access to the corresponding cloud service without disclosing or sending any credentials of the user.

Following the creation of the private key in volatile memory, the application computes two non-secret quantities which are stored, in the clear, on the mobile phone. The first is the public key which is a unique point in the square field of ECC. The point has an X and a Y value, both of which are integers of length 64 hexadecimal digits. This quantity can be used to encrypt any document requiring high security. In addition, the public key is used to encrypt all URLs to user internet sites which contain financial or sensitive user information. The second quantity is a bitcoin address which the user may use to store bitcoins. It is only possible to decrypt the documents or URLs by scanning the user's wrist to reconstruct the volatile private key (biocode). In addition, this is also the process to spend any coins associated with the bitcoin address.

The instant invention also supports a bitcoin liquidation service that is not a traditional currency exchange. In this service, there is no Internet site and no usernames or passwords. Cryptocurrency exchanges do not provide real bitcoin addresses or private keys. They simply display an account evidencing the client's position in each currency, including BTC, with a promise to liquidate when requested. The biocode bitcoin address is a real address which may be spent on the public blockchain using the in vivo private key (biocode) to sign any transaction. In addition, the PBC phone application may be used to receive BTC from another address or to liquidate to USD from the bitcoin address on the phone. No website is accessed, and no user credentials are employed for these transactions. In addition, there is no user account, however, the application will report the amount of BTC available in the phone bitcoin address.

The instant invention also describes a method to encrypt large documents rapidly with elliptic curve cryptography (ECC). ECC is generally not recommended for large documents due to the tedious task of finding and then imbedding the document in an existing point in the 2D field. The probability of finding a suitable point is not certain and moreover each coordinate (X and Y) of every point are only 32 Bytes long. However, the instant invention provides a method in which a document of arbitrary size is encrypted and decrypted with certainty using the secp256k1 version of ECC. This is also the version employed by the cryptocurrency bitcoin. The method avoids the uncertainty of finding a suitable point in the square field by constructing a database of 32 Byte strings sᵢ where i is the number of ith 32-character string in the entire document including spaces and punctuation.

The same number of temporary private keys is calculated by using a variation of the second factor photograph to transform the data array from the in vivo UCPs with a different algorithm for each temporary private key. Each private key is a random 256-bit key (64 hexadecimal digits) denoted by r₂ⁱ. For each temporary private key, we calculate a corresponding temporary public key Pⁱ:

Pⁱ(Xⁱ,Yⁱ)=r₂ⁱ G₀

where G₀ is the generator point for the elliptic curve. There are plenty of online calculators to create these temporary public keys following the construction of the private keys. The next step is to imbed the hexadecimal strings into the X value of each public key by a simple subtraction or

Jⁱ=Xⁱ−sᵢ

At this point, each sᵢ is replaced in the database with Jⁱ. The database of sᵢ is deleted (not hidden). Now once can construct one last temporary private key denoted by r₁ and compute one more public key and an additional point.

P₁=r₁ G₀

P₂=r₁P

where P is the user's Public Key corresponding to the Princeton Biocode (user's unknown and unknowable private key). Finally, modular point addition is used to create and hide the database of points used to imbed the original string. For each i,

Pⁱ=Pⁱ(Xⁱ, Yⁱ)+P₂

All of these new points Pⁱ must be added to the database along with the Jⁱ inserted previously. The reason this works is because it is impossible to derive the original points from knowing the addition result.

This process is extremely fast and is not limited by the size of the documents being encrypted. Since there are 10⁷⁷ points available in the square encryption field, a virtually infinite number of points to imbed the target document. Following this procedure, all temporary keys and imbed points are deleted (not just hidden). They are not necessary for the decryption function which only requires the private key (biocode). This decryption process can recover the imbed points (and hence each 32 byte segment) by simply computing:

Pⁱ(Xⁱ,Yⁱ)+P₂−kP₁

which the app does after scanning the user's wrist to compute the private key k (biocode). The second two terms cancel which recovers the imbed points because:

P₂−kP₁=r₁P−kr₁ G₀=0

where, by definition,

P=k G₀

The original 32 byte plaintext segments can be recovered from the Xⁱ values of all the imbed points by the subtraction:

sᵢ=Xⁱ−Jⁱ.

### EXAMPLES

### Information-Carrying Particles Embedded in Skin

Skin is the body's largest and most accessible organ and has been used as a canvas to express identity and group identification for thousands of years. The insertion of pigments or other information-carrying particles however is not limited to using skin—nearly every organ of the body can in principle be used for the secure storage of a biocode. Biocodes inserted into skin can be hidden and made virtually invisible through microwriting using ink made of or containing nano- or microparticles. These particles or pigments typically have average sizes between 100 nm and 1 μm, with some nanoparticles having sizes between 10 nm and 100 nm, and some even smaller, between 1 nm and 10 nm. Larger microparticles as well as agglomerates can have average sizes between 1 μm and 10 μm, and some even larger, between 10 μm and 100 μm. For the purposes discussed here, particles or pigments containing biocode information can also have sizes between 100 μm and 1 mm, or of any combination of the sizes listed above.

Particles carrying biocode information can comprise various shapes and formulations and may consist of different types of particles that can be either combined in one formulation or administered and read independently from each other and through the use of different devices, technologies and processes. In one embodiment, the particles are inert and passive until interrogated by a coded pulse of light, after which they ‘answer’ with the information stored inside each particle. The information can be encoded via specific properties that are specifically chosen for the selected nanoparticles. Examples of such specific properties are: specific wavelengths of excitation or emission, specific fluorescence or phosphorescence lifetimes or intensities of emission, specific quenching or enhancement of emission based on externally applied chemical or physical factors that influence such properties, size or shape of individual particles as well as size or shape of clusters formed by multiple particles, magnetic moment, orientation, the relative arrangement of multiple particles with respect to each other, the relative arrangement of multiple particles into patterns or layers in two or three dimensions, or any combination thereof.

In another embodiment, the particles are formulated such that on the outside they are indistinguishable by the body of a person from other types of particles, pigments, compounds or colors that are already in common use or FDA approved for example for use in tattoo inks, cosmetics or food additives.

In one example, the particles contain multiple fluorescent dyes or other emitters that serve as the information carriers. These are preferably excited with the same light source and then emit different combinations of wavelengths or specific life time signatures that in combination encode the biocode. Light sources and detectors suitable for optical reading of biocodes may comprise bandpass filters or other suitable emission and excitation filters that selectively transmit photons of one or more selected wavelengths.

For example, the particles may be ‘multiple fluorophore fluorescent particles.’ They may comprise a variety of fluorescent dyes, quantum dots, rare earth compounds, some of which can be optically excited in the IR and fluoresce in the visible spectrum, or some of which are excited in the UV or the visible spectrum. Such compounds preferably comprise a large Stokes shift or a large fluorescence emission life time that can be utilized to suppress optical background originating from the excitation source. Light sources and detectors they may be time-gated to suppress background emissions of autofluorescence or scattered excitation light. Other examples include particles comprising fluorescently doped silicas and sol-gels, hydrophilic polymers (hydrogels), hydrophobic organic polymers, semiconducting polymer dots, quantum dots, carbon dots, other carbonaceous nanomaterials, upconversion particles, noble metal particles (such as gold and silver), or dendrimers. Any combination of the above can be utilized.

Microwriting of Particles into the Skin

In one embodiment, microwriting is performed through a self-administered and painless microneedle skin patch. The information is transferred into the skin within minutes by taking the sterile patch supplied by the manufacturer out of its protective sleeve and pressing it onto the skin—like a band-aid—after cleaning the desired skin location with a disinfectant wipe and using topical anesthetic if desired. The sensation during biocode skin writing is that of pressure, not pain.

A patch is typically about 7×7 mm² (the size of a small fingernail) and consists of an array of hundreds or thousands of microneedles that are programmed with the biocode. Other microneedle patches can have different shapes and surface areas of about 1-10 mm², 10-100 mm², 100-1000 mm², 1000-10,000 mm² or larger than 10,000 mm². Typical numbers of microneedles per patch are 10-100 microneedles or 100-1000 microneedles. Larger patches contain 1000-10,000 microneedles, 10,000-100,000 microneedles, or 100,000-1 million microneedles. Some patches may contain more than 1 million microneedles. Further, microneedles typically are of 150-1500 μm size in length, 50-250 μm in width, and 1-25 μm in diameter. Microneedles cause micron-sized pore formation by skin puncturing. These channels can act as a direct route for the delivery of drugs or particles into the top layers of the skin.

In a preferred embodiment, the microneedles are pre-loaded with biocode-containing particles, and after attachment to the skin, dissolve to provide a consistent, accurate, effective and permanent delivery of the customer's desired code. For example, a biocode may consist of an encoding protocol that resembles the 2D pattern of a QR matrix code, formed on an area of limited size as described above by particles that are invisible to the naked eye. Such a biocode may contain thousands or millions of individual positions in a grid pattern and consequently is able to encode many orders of magnitude more information than a typical QR code can. If desired, such 2D codes can themselves be further encrypted for additional security, multiple-factor authentication and third party validation.

In a preferred embodiment, it can be advantageous that the particles are arranged in a defined grid formation so that existing software and programs (such as smart phone applications) can be used for reading a biocode, thereby providing device compatibility, ease of access and reduced development costs. In another preferred embodiment, it can be advantageous that the particles are arranged in grids or formations that are different from currently used encoding pattern so that existing software and programs cannot be used for reading a biocode, thereby providing added security against possible hacking.

In yet another preferred embodiment, the arrangement of particles in a 2D pattern to form a biocode is randomly generated so that no currently existing encoding profile matches the arrangement of the particles. In this case, the biocode is generated after the random generation of the particle pattern, including before or after the administration of this pattern to the skin (or another suitable organ). In this embodiment, the pattern is associated with the desired biocode after the pattern's creation through a one-time correlation procedure during which the random but unique particle pattern is uniquely associated with a specific biocode. It is also possible to associate multiple biocodes with one or more such patterns of particles, whether in 2D or 3D arrangement, or to use combinations of the embodiments described above.

Manufacture of Microneedle Patches with Patterns Comprising Particles

Typical techniques for filling microneedles in a microneedle patch involve loading all microneedles with the same compound, fluid, particles or other reagents, or combinations thereof. These techniques are well suited for applications that merely utilize microneedle patches as a delivery vehicle into the skin and consequently into the body, such as for vaccination or purported cosmetic purposes. However they are generally unsuitable to deliver compounds, fluids, particles or other reagents, or combinations thereof in predefined patterns where only some of the microneedles are filled (or present) while others are not.

As an example, a microneedle patch consisting of a 50×50 arrays of needles can easily be filled entirely (“all positions black”) or not at all (“all positions blank”). The microneedle patch may be filled partially (“all positions on left black, all positions on right blank”). It should be appreciated that it is less straightforward to fill (or keep) individual positions of the microneedle patch grid in order to generate a pattern that resembles a QR-type code, where many positions are of the opposite type (black or white) than their nearest neighbors.

In one preferred embodiment, the microneedles are selectively and individually filled through the use of accurate deposition technologies for fluids, nano- or microdroplets, inks, or particles. Examples for such 2D addressable technologies are: ink-jet printing, electrostatic-force-assisted micro- or nanodroplet dispensing, sub-microliter and nanoliter direct pipetting, microscreen contact printing, microscreen-assisted electrospray deposition, capillary contact wetting and printing, or tip-assisted electrohydrodynamic jet printing.

In another preferred embodiment, the microneedles are all filled but then selectively emptied, removed or destroyed in order to form a desired pattern of particles to be inserted as a biocode. Examples for such 2D addressable technologies are: ablation or evaporation of individual microneedles and their content by a scanning laser (similar to techniques commonly used in precision manufacturing, cutting, engraving and thermal processing), selective removal of individual microneedle content by suction, pipetting, dilution or flushing, abrasion or destruction of individual microneedles and their content through mechanical action, such as through a plunger or stamp with suitably high resolution.

The techniques described in these embodiments are suitable for the manufacture of both ordered arrays and random patterns of nanoparticle-based biocodes. Microneedles are typically manufactured in ordered arrays, but techniques are available to generate microneedles in random arrays. An example is the enlargement of defects by reactive ion etching (RIE), chemical etching or other means after such defects or holes have initially been formed through directed exposure to high energy particles or ions. These patterns can then be used as negative molds for the fabrication of microneedles.

Ordered or ‘Random’ 2D patterns can also be generated on a computer and then transferred to a 2D mold by laser-based ablation and subsequent etching, thereby generating only such microneedles that are to be filled, thus making the filling process easy, for example by full immersion or wiper-based application of fluids, nano- or microdroplets, inks, or particles and followed by optional vacuum treatment to ensure that the reagents enter the entire volume provided by hollow microneedles.

Alternatively, fluids, nano- or microdroplets, inks, or particles can directly be combined with the polymers and reagents that are involved in the fabrication of microneedles. In this embodiment, the formation of the microneedles and their desired functional content are manufactured in one step, eliminating the need to first make and then selectively fill the microneedles. This embodiment can utilize any of the techniques described above, or any combination thereof.

### Microreading of Particles in the Skin

Microreading is performed through an application (app extension) on a smart device that is capable of reading microdots with its back surface. If invisible fluorescent smart nanoparticles are selected as the biocode information carriers, then a designated microreading device provided to the customer is used. Other options are readers that are shaped as a (functional) pen which is swiped over the biocode patch for readout, a watch or wristband/bracelet, or a ring that is turned (twisted) over a programmed biocode skin patch. After reading the Biocode, the microreading device securely transmits the biocode to the user's device of choice for display or direct use, such as to instantly unlock important documents, devices or databases. The device can optionally be set up to request a second factor identification from a trusted third party in order to complete the unlocking process, thereby securing the identification process against possible biohacking or extortion.

DNA-Based Encoding within Nanoparticle Ink

Another embodiment of biocode encoding is performed through the same simple, self-administered skin patch used for microwriting, except that it comprises nanoparticles that optionally or additionally contain synthetic DNA or other small types of information carriers as a high density information storage medium. A single smart nanoparticle can hold sufficient information to encode an entire encyclopedia's worth of information. Artificial gene synthesis, sometimes known as DNA printing, is a method in synthetic biology that is used to create artificial genes in the laboratory. Based on solid-phase DNA synthesis, it does not have to begin with preexisting DNA sequences. Therefore, it is possible to make a completely synthetic double-stranded DNA molecule with no apparent limits on either nucleotide sequence or size. Examples of other small information carriers are RNA, PNA, LNA and other chemical variations as well as non-biological molecules.

The amount of information which can be stored by nanoparticle-embedded DNA is vastly greater than any QR or microwriting code can hold, but there may be no detectable difference to the body that would distinguish nanoparticles containing DNA-based biocodes from ‘plain’ nanoparticles that function as mere smart inks. Both types of smart nanoparticles can also be combined and used at the same time, holding two orthogonal biocodes. For example, sequencing of the DNA-based biocodes can be used to retrieve backup copies of user's external data matrix, instruction array derived from the second factor picture, or a private key itself.

Reading of nanoparticle-embedded biocodes is performed through so-called next-generation sequencing on a nanopore device, which is smaller than a smartphone and can be operated directly by the customer after moderate training. The biocode information is available for use after about 4-6 hours. Alternatively, the customer visits an accredited service point that performs the readout as a service.

To obtain the embedded DNA for sequencing, a proprietary tape strip is firmly attached to and then removed from the selected skin patch. The removal is painless (optionally after shaving the area first) and carries sufficiently many nanoparticles to robustly retrieve the biocode. The nanoparticles are chemically opened to release, amplify and sequence the DNA. Each Biocode contains a ‘tag’ (=unique molecular identifier, UMI) that allows a user to selectively extract it over any other DNA that may also be present. The information is then back converted into bits or characters.

Moreover, a biocode can be encrypted through a second key before insertion into the nanoparticles to protect it from bio-hacking, or the skin biocode can be the encryption key to a second factor that is stored offline, for instance on a thumb drive or in a trusted, secure facility or a safe deposit box. A pair of keys represents two-factor authentication, one imbedded in the skin and one stored elsewhere. Biocodes are protected from loss, hacking and extortion by user-selected orthogonal encoding and decoding choices.

### Use of a Biocode Application

In one embodiment of the biocode application, the user is required to scan an external data matrix with her smartphone or a similar device in order to decrypt a private key and use it to unlock a specific application, or App. The external data matrix can be located in any location, with a preferred location being for instance the wrist of the left hand for a right handed user. A user in that case is typically holding the phone or other device with one hand in order to scan the data matrix located for instance her left wrist, which means that the left hand is not typically available for other action involving the smartphone, such as for selecting a specific application from a range of icons displayed on the smartphone.

It is in general not convenient to select the application with one hand while at the same time using the same hand to position the smartphone correctly over a data matrix in order to initiate the process to unlock the private key. This operation is possible by using a thumb but does require a significant amount of one-handed coordination. It can be conducted with a single hand by positioning the smartphone illumination flash or IR VCSEL and camera imaging detector so that the external data matrix patch is properly read and deciphered and using for instance a thumb to select the application for which the private key is supposed to be applied, but it is a potentially awkward and difficult operation especially for individuals who do not have perfect dexterity or control.

Alternatively, an application can be selected before the unlock operation is carried out, but in that case it requires two separate steps to be performed. In other embodiments, the smartphone can be held with one hand with the phone flash or VCSEL excitation light and rear-facing camera facing to the data matrix, while at the same time displaying possible apps from which one should be selected to generate the private key and unlock the application that is controlled by the app.

This operation results in a simplified workflow compared to currently used methods and can be controlled in several ways using technologies that are embedded in nearly every current smartphone. Examples are the detection of external magnetic field direction, which allows a smartphone to recognize relative changes in its angle and orientation with respect to the Earth's magnetic field, inertial motion sensors that detect the movement of the smartphone in space, such as changes in its a relative angle and orientation in space, or detection of lateral movements in space.

The same types of movement can also be detected optically through image processing software that recognizes a lateral, angular or rotational movement of the smartphone with respect to a background that is visible in its camera. Lateral and rotational movements, zooming in and zooming out can easily be detected and initiated by rotating or by moving the smartphone, for instance by decreasing or increasing its distance from an object or a background that is visible in the smartphone's camera view, or by tilting the phone in any axis, or by rotating the phone around an axis roughly perpendicular to its screen. Such visually detected motions can be used to trigger a change in the applications (or apps) that are presented to the user and especially highlighting different apps that the user can then select. In one example, a serious of apps that are presented in an XY grid can be selected by tilting the phone in the two axes that correspond to the axis in which the applications are displayed on the smartphone's screen. For instance rotation around the x axis would select different rows of apps, whereas rotation around the y-axis would select different columns in the list of apps displayed on the smartphone screen.

### Biocode Composition

One preferred embodiment of a biocode composition comprises a unique code of sub-μm size colored, fluorescent, phosphorescent or luminescent particles which for embedding into the body of a person while doing no harm, wherein the biocode composition is invisible to the naked eye and inaccessible under circumstances of everyday life, for retrieving with a device and a method making available the biocode only to the user, wherein the biocode does not decay over at least one year and the method providing the biocode can be deactivated, erased or over-written if desired by the user.

In one embodiment, a biocode comprises UCPs that are embedded into the skin of a user in a unique pattern that can be detected and translated into a key with which a secure device or database is then unlocked. In a preferred embodiment, a smartphone is used for both illuminating the UCPs and detecting an image of the biocode pattern formed by the UCPs or other types of light-emitting particles.

A smartphone can illuminate particles by a built-in flash or flashlight function (white light produced by light emitting diodes, LEDs) or by an IR LED or laser (such as a VCSEL). To overcome a decrease in excitation intensity due to beam divergence in space and provide a power density sufficient to excite UCPs or other particles, a passive or active (containing electrical components in addition to those of the smartphone) optical device can be provided or attached to the smartphone to facilitate: (a) the retention of illumination power density from the smartphone's emitter surface to the location of the biocode array; and (b) an optical distance from the biocode array to the smartphone's detector that allows imaging or detecting individual dots in the array. The dots and patterns of the biocode array can then be processed and decoded into an access key or passcode.

### Use of Mobile Device to Directly Image Patterns of Light-Emitting Particles

In specific examples and as depicted in FIG. 26 and FIG. 27, the smartphone VCSEL is approximately 936 nm and the beam spread is approximately 17 degrees (conical), peak power directly at the smartphone surface 34 mW. The VCSEL may be pulsed in approximately 10s of nanoseconds (ns) to be eye-safe. A smartphone's built-in white light flash is considered eye-safe due to the eye's natural reflexes and can be modified for intermittent illumination. White light excitation with appropriate excitation and detection filters (bandpass, low pass, high pass, low cut-off, high cut-off or any combination thereof) can be advantageous for the suppression of background during particle imaging, in particular when time-gating of both the emitter (LED) and detector are used in combination with particles that have particularly long fluorescence or phosphorescence lifetimes, such as 1, 10, 100 or 1000 microseconds or 1, 10, 100 or 1000 milliseconds. In one embodiment, the UCP pattern in the biocode data matrix is detected by taking a picture through the use of a smartphone's built-in white light flash or VCSEL and again taking a picture without the flash or VCSEL being activated. The biocode data matrix pattern generated by the UCPs then detected by comparing and subtracting the two pictures (with and without flash/VCSEL) from each other, thereby removing background light as seen by the smartphone camera when the flash or VCSEL are not activated.

The VCSEL output wavelength is detected by some smartphones and can contribute to unwanted background. It can be suppressed through the use of an IR blocking filter in front of the detector/camera or, if no VCSEL light is desired, by blocking the output elsewhere along its path from the VCSEL emitter to the detector. A ‘FandyFire 501 IR’ flashlight uses 940 nm from four LEDs. It can be used to see yellow UCPs when close (2-3 cm). An IR laser pen with 50-70 mW power uses 980 nm. UCPs are brightly detected visually and via smartphone at distances greater than 20 cm.

### Excitation and Emission of Light-Emitting Particles

A typical UCP absorption maximum is 976 nm with a narrow (5 nm) peak and a shoulder at 936 nm of about 50%. The mobile device VCSEL is suboptimal for excitation. A 980 nm ‘currency detection’ laser pen is ideal. Emission peaks of the bright yellow UCPs are at 546 nm and 660 nm. Lifetime is in milliseconds (ms). Other suitable types of light-emitting particles (not up-converting) also have ms lifetimes. These particles are advantageous for time-gated excitation by visible light (such as the smartphone flashlight or an external device) and their subsequent detection in the visible or in the IR, thus providing increased signal-to-noise. UCP excitation to emission photon conversion efficiency is low compared to other emitters and greatly depends on excitation intensity.

Options for Illumination and Detection using a Smartphone by Using an External (Active or Passive) Device

Focused illumination facilitated by an excitation component of an active external device, such as a dedicated LED or laser diode, which can emit in the visible spectrum or in the IR. Such an illumination source can be mounted very close to the biocode pattern for maximum power density, while still being within eye-safe limits at all times. Illumination can occur sideways at an angle, meaning in a direction that is not perpendicular to the object plane in which the biocode pattern is located and therefore does not or does only partially obscure the ability of the smartphone's camera to properly and fully image the biocode pattern while it is being illuminated by an excitation component of the active external device.

A macro lens attachment (a convex lens or group of lenses that magnify the image of the object plane in which the biocode pattern is located) allows the smartphone to be located closer to the object plane than without an attachment. The lens attachment can optionally comprise one or more filters to suppress excitation light and background emission and thereby improve signal to noise ratio.

Time gating of excitation and/or detection can suppress background and increase signal to noise. Light-emitting particles, dyes or quantum dots with excitation at shorter wavelengths than their emission wavelength (down-conversion particles) are a preferred embodiment where the emission intensity of UCPs under a given excitation intensity is considered too weak for particular situations, such as conditions involving bright light or sunlight or high radiant proximity IR. If an ‘invisible’ biocode pattern is desired, the particles can be selected to be excitable in the red with emission in the IR. A smartphone detects and images in the IR, in particular, with an appropriate IR high pass filter.

A separate device attached to or linked to the smartphone via USB, cable, Bluetooth, WIFI can perform direct excitation and proximity detection of the biocode array. (“Biocode Square card reader”). Magnetic detection of magnetic nano- or microparticles embedded in a pattern and generating a magnetic biocode is feasible and can be implemented in ways that are compatible with magnetic resonance imaging.

Examples for Illumination and Detection using a Smartphone by using an External Attachment or Passive Device Connected to the Smartphone

An attachment device to a smartphone allows imaging of a dot pattern (the biocode) emitting in visible light from a distance or optical path length of 6-10 cm between the pattern, with the smartphone camera allowing for proper focusing/autofocusing. In one embodiment, a passive tube or light guide device internally reflects and redirects visible or IR light on a ‘detour’ that increases path length and thereby allows focused imaging of the external data matrix, while keeping the distance between excitation IR VCSEL small (1-2 cm). Doing so avoids loss of excitation power density due to the beam divergence of the VCSEL (typically about 17 degrees).

A passive or active optical device can focus IR or visible light used for excitation directly onto the object plane in which the external data matrix is located as well as provide a magnified and focused image of the external data matrix. The device can comprise alignment points, a reference window that is placed over the biocode pattern or other reference guides to ensure alignment of the focused IR beam with the pattern in the object plane.

Advantageously, the image distance can be made significantly smaller when using a (convex) lens. The lens may be made of a cheap material (PMMA or other) and can include multiple sections (like bifocal lenses) where one directs the VCSEL output onto the biocode pattern and the other focuses the fluorescent image of the biocode onto the camera sensor with a magnification that improves detection and decoding efficiency by the smartphone.

A light guide or waveguide tube or internally reflecting ‘stick’ can redirect the illumination from a VCSEL or LED so that it comes in sideways onto the biocode pattern without obscuring the path directly to the camera. A weak convex lens provides a focused image at reduced distance from the smartphone camera. A lens used for improved imaging can at the same time be used to focus VCSEL output and directly illuminate the pattern for imaging. Such a lens may consist of multiple components with different focal lengths (resembling bifocal glasses for both reading the distance viewing) so as to compensate for the different refraction and focusing distances required for light of different wavelengths (IR versus visible, various different colors of visible light), and as used either in the illumination or detection optical pathways. Bandpass, low pass and IR blocking filters can be used to improve signal to noise. Signal integration over time and time gated excitation (VCSEL) and/or detection (phone CMOS detector) can be used to improve signal to noise.

The output of a light guide ‘tube’ or ‘stick’ can easily be redirected by mirrors or by bending the stick or by combinations thereof to create an illumination of the biocode that is coming in from the side in such a way that the device (stick or tube) does not (or only minimally) interfere with the ability to directly image the biocode using the smartphone camera sensor. FIG. 26 shows a simple sideways and angled mirror 2605 such as used on an inside-reflective hollow tube or on fiberoptic cables and endoscope cameras. Other embodiments for separating colors and selectively increasing their excitation or imaging pathlengths can be utilized and adapted as well.

Both illumination and imaging can be done through a suitable lens. PMMA passes radiation up to 2800 nm, providing a simple and cheap device that includes alignment of the invisible IR beam to the biocode pattern. As an example, a 6 cm long/5 mm diameter is used PMMA ‘stick’ to extend the VCSEL output and bring it to the pattern. Another embodiment is the reflective inner surface of a steel or aluminum tube, which represents a fiberoptic ‘flashlight’ that is held 5-10 mm above the pattern in order to illuminate it. The pattern is imaged with the same phone as long as the camera (and autofocus) is located sufficiently out of the way of the VCSEL to not get partially blocked by the PMMA ‘stick’ or light guide.

The stick or light guide can be bend or angled or another optical arrangement can be added so that nothing blocks the image pathway to the camera. The stick can have a holder that folds out and aligns it with the VCSEL. The light guide or PPMA stick can be personalized on the outside with the customer's preferred picture or pattern and it is delivered free in a protective sleeve like a pen with the microneedle patch. The light guide or PPMA stick may be incorporated into a smartphone case and may conveniently fold out for usage and then retract of fold back into the case for safe storage.

A multiple-mirror- or PMMA prism arrangement as part of the external optical device can hold the iPhone's VCSEL 5-10 mm to a user's wrist and then redirect the image and increase path length to allow focused imaging by the smartphone's camera. An IR block and/or a bandpass filter can be added into the detection pathway to suppress background and increase signal to noise. The device can comprise active components such as external illumination with a IR LED or laser diode and be operated and communicating with the smartphone either independently (with its own power supply) or through a USB or other cable, Bluetooth or WIFI connecting wirelessly with the smartphone.

### Computing System

As used herein, the term “computer” refers to a machine, apparatus, or device that is capable of accepting and performing logic operations from software code. The term “application”, “software”, “software code” or “computer software” refers to any set of instructions operable to cause a computer to perform an operation. Software code may be operated on by an “engine” or processor. Thus, the methods and systems of the present invention may be performed by a computer or computing device having a processor based on instructions received by computer applications and software.

The term “electronic device,” “mobile device,” or “client device,” as used herein is a type of computer comprising circuitry and configured to generally perform functions such as recording audio, photos, videos and handwritten notes; displaying or reproducing audio, photos, videos and handwritten notes; storing, retrieving, or manipulation of electronic data; providing electrical communications and network connectivity; or any other similar function. Non-limiting examples of electronic devices include: personal computers (PCs), workstations, laptops, tablet PCs, cell phones, digital music players, digital notepads, digital pens or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as smartwatches, fitness rings, fitness trackers, etc.

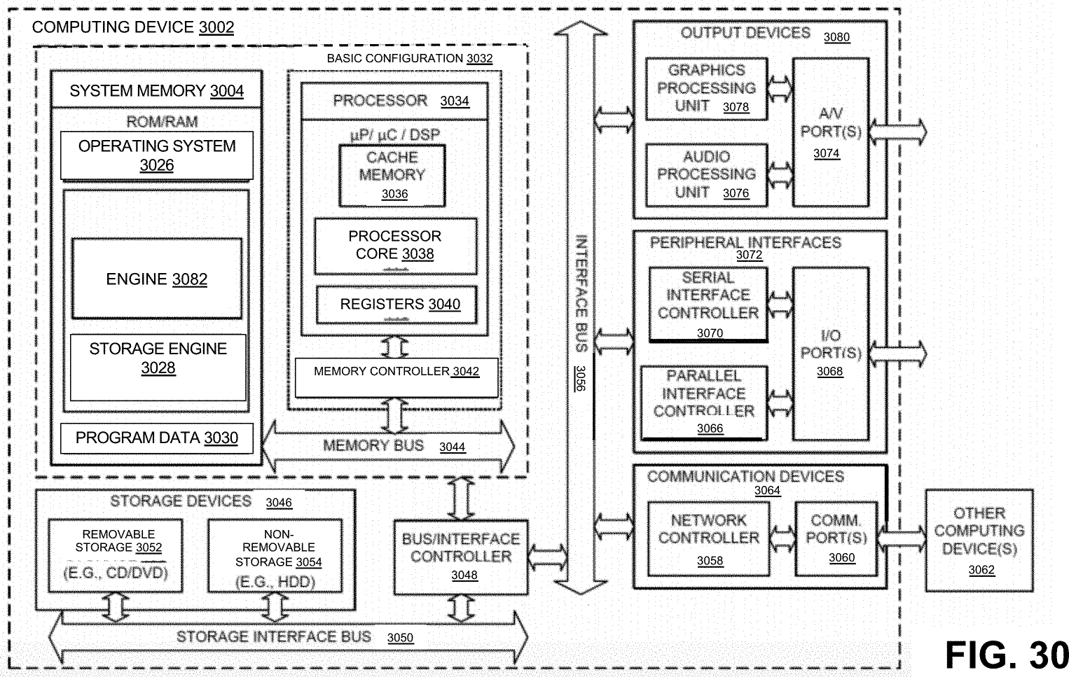

In some embodiments, the present invention may be a computer system, a method, and/or a mobile device, smartphone, or computing device or the computing device 3022 (of FIG. 30). For example, the computer system and/or the computing device 3022 may be utilized to implement one or more methods described herein.

A basic configuration 3032 of a computing device 3022 is illustrated in FIG. 30 by those components within the inner dashed line. In the basic configuration 3032 of the computing device 3022, the computing device 3022 includes a processor 3034 and a system memory 3024. In some examples, the computing device 3022 may include one or more processors and the system memory 3024. A memory bus 3044 is used for communicating between the one or more processors 3034 and the system memory 3024.

Depending on the desired configuration, the processor 3034 may be of any type, including, but not limited to, a microprocessor (μP), a microcontroller (μC), and a digital signal processor (DSP), or any combination thereof. Further, the processor 3034 may include one more levels of caching, such as a level cache memory 3036, a processor core 3038, and registers 3040, among other examples. The processor core 3038 may include an arithmetic logic unit (ALU), a floating point unit (FPU), and/or a digital signal processing core (DSP Core), or any combination thereof. A memory controller 3042 may be used with the processor 3034, or, in some implementations, the memory controller 3042 may be an internal part of the memory controller 3042.

Depending on the desired configuration, the system memory 3024 may be of any type, including, but not limited to, volatile memory (such as RAM), and/or non-volatile memory (such as ROM, flash memory, etc.), or any combination thereof. The system memory 3024 includes an operating system 3026, one or more engines, such as an engine 3082, and program data 3030. In some embodiments, the engine 3082 may be an application, a software program, a service, or a software platform, as described infra. The system memory 3024 may also include a storage engine 3028 that may store any information disclosed herein.

Moreover, the computing device 3022 may have additional features or functionality, and additional interfaces to facilitate communications between the basic configuration 3032 and any desired devices and interfaces. For example, a bus/interface controller 3048 is used to facilitate communications between the basic configuration 3032 and data storage devices 3046 via a storage interface bus 3050. The data storage devices 3046 may be one or more removable storage devices 3052, one or more non-removable storage devices 3054, or a combination thereof Examples of the one or more removable storage devices 3052 and the one or more non-removable storage devices 3054 include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus 3056 facilitates communication from various interface devices (e.g., one or more output devices 3080, one or more peripheral interfaces 3072, and one or more communication devices 3064) to the basic configuration 3032 via the bus/interface controller 3056. Some of the one or more output devices 3080 include a graphics processing unit 3078 and an audio processing unit 3076, which are configured to communicate to various external devices, such as a display or speakers, via one or more A/V ports 3074.

The one or more peripheral interfaces 3072 may include a serial interface controller 3070 or a parallel interface controller 3066, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 3068.

Further, the one or more communication devices 3064 may include a network controller 3058, which is arranged to facilitate communication with one or more other computing devices 3062 over a network communication link via one or more communication ports 3060. The one or more other computing devices 3062 include servers, the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 3024, the one or more removable storage devices 3052, and the one or more non-removable storage devices 3054 are examples of the computer-readable storage media. The computer-readable storage media is a tangible device that can retain and store instructions (e.g., program code) for use by an instruction execution device (e.g., the computing device 3022). Any such, computer storage media is part of the computing device 3022.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein regarding illustrations and/or block diagrams of methods, computer systems, and computing devices according to embodiments of the invention. It will be understood that each block in the block diagrams, and combinations of the blocks, can be implemented by the computer-readable instructions (e.g., the program code).

The computer-readable instructions are provided to the processor 3034 of a general purpose computer, special purpose computer, or other programmable data processing apparatus (e.g., the computing device 3022) to produce a machine, such that the instructions, which execute via the processor 3034 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 3022), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

Another embodiment of the invention provides a method that performs the process steps on a subscription, advertising, and/or fee basis. That is, a service provider can offer to assist in one or more method steps described herein. In this case, the service provider can create, maintain, and/or support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method executed by a computing device, the method comprising:
in response to a user launching an application on the computing device, the computing device housing a second data matrix, and holding the computing device over a location of a first data matrix external to the computing device, reading the first data matrix;
processing the first data matrix utilizing the second data matrix such that the second data matrix provides a means for stepping through the first data matrix to create a private key; and
utilizing the private key to unlock user data stored in the application.

2. The method of claim 1, wherein the location comprises a biological location.

3. The method of claim 2, wherein the biological location is selected from the group consisting of: a body of a human, a skin of the human, a body of an animal, and a skin of the animal.

4. The method of claim 1, wherein the location comprises a non-biological location.

5. The method of claim 4, wherein the non-biological location is selected from the group consisting of: a device, a computer location, a surface, a home, a book, an office, outdoors, a piece of clothing, a painting, a wallpaper, a painted surface, a tool, and an article of manufacture.

6. The method of claim 1, wherein the private key is erased immediately after the private key is created and used.

7. The method of claim 1, wherein the first data matrix comprises a data matrix patch.

8. The method of claim 7, wherein the data matrix patch comprises dots containing up-converting particles (UCPs).

9. The method of claim 8, wherein the data matrix patch is a biocode that consists of an encoding protocol resembling a two-dimensional pattern of a QR matrix code that is invisible to a human eye until exposed to one or more beams of infrared light or visible excitation light from a source.

10. The method of claim 9, wherein the source is selected from the group consisting of: a light emitting dioide (LED) of the computing device, a vertical-cavity surface-emitting laser (VCSEL) emitter of the computing device, an external attachment to the computing device, and a passive device connected to the computing device.

11. The method of claim 1, wherein the computing device is selected from the group consisting of: a smartphone, a laptop computer, a desktop computer, a tablet computer, a personal computer, and a wearable computer, and wherein the wearable computer is selected from the group consisting of: a smart watch, a smart bracelet, a smart wristband, a smart ring, a smart necklace, and an eyeglasses computer.

12. The method of claim 11, wherein the computing device comprises the smartphone.

13. A method executed by a user, the method comprising:
launching an application on the computing device, wherein the computing device houses a second data matrix;
holding the computing device over a location of a first data matrix external to the computing device;
moving the computing device to display application icons;
selecting an icon from the application icons associated with a desired account;
reading, via the computing device, the first data matrix;
processing, via the computing device, the first data matrix utilizing the second data matrix such that the second data matrix provides a means for stepping through the first data matrix to create a private key; and
utilizing, via the computing device, the private key to unlock user data stored in the desired account.

14. The method of claim 13, wherein the first data matrix is invisible to a human eye.

15. The method of claim 13, wherein a movement of the computing device to display the application icons is selected from the group consisting of: a transverse motion in an x direction and a y direction of dimensions of the computing device, a rotational motion within an image plane of the computing device around an axis perpendicular to the dimensions of the computing device, and a tilting motion around an axis aligned with a longest dimension of the computing device.

16. The method of claim 13, wherein the location is a biological location, and wherein the biological location is a skin of a human.

17. The method of claim 16, wherein the first data matrix is received at the location by:
positioning a data matrix patch of up-converting particle (UCP)-tipped microneedles over the skin of the human;
pushing the data matrix patch into the skin of the human; and
in response to removing the data matrix patch from the skin of the human, leaving UCP tips of the UCP-tipped microneedles embedded in the skin of the human such that the data matrix patch is installed beneath a surface of the skin of the human.

18. The method of claim 17, wherein, after a healing of the skin of the human, an epidermis or dermis of the human contains the UCPs in a pattern as a biocode matrix.

19. The method of claim 18, wherein the biocode matrix consists of an encoding protocol resembling a two-dimensional pattern of a QR matrix code that is invisible to a human eye until exposed to one or more beams of infrared light or visible excitation light from a source.

20. The method of claim 19, wherein the source is selected from the group consisting of: a light emitting dioide (LED) of the computing device, a vertical-cavity surface-emitting laser (VCSEL) emitter of the computing device, an external attachment to the computing device, and a passive device connected to the computing device.

21. The method of claim 19, wherein the two-dimensional pattern is a defined grid formation readable by one or more software and/or programs of the computing device.

22. The method of claim 19, wherein the two-dimensional pattern is a grid or is randomly generated and unreadable by one or more software and/or programs of the computing device.

23. The method of claim 17, wherein dimensions of the data matrix patch are selected from the group consisting of: approximately 1-10 mm², approximately 10-100 mm², approximately 100-1000 mm², approximately 1000-10,000 mm², and larger than approximately 10,000 mm².

24. The method of claim 23, wherein the dimensions of the data matrix patch are approximately 1-10 mm².

25. The method of claim 24, wherein the dimensions of the data matrix patch are approximately 7×7 mm².

26. The method of claim 17, wherein a quantity of the UCP-tipped microneedles in the data matrix patch are selected from the group consisting of: approximately 10-100 microneedles, approximately 100-1000 microneedles, approximately 1000-10,000 microneedles, approximately 10,000-100,000 microneedles, approximately 100,000-1 million microneedles, and more than 1 million microneedles.

27. The method of claim 17, wherein an ink jet unit moves relative to unfilled microneedles in a pattern and dispenses fluid droplets comprising UCPs into the unfilled microneedles to fill the UCP-tipped microneedles.

28. A method for generating a random number for use in creating a data matrix, the method comprising:
selecting, by a user, a method for generating a random number;
using a random number generator for obtaining the random number; and
in response to the user selecting a type of data matrix, a location for the data matrix, and a number of quadrants for the data matrix, using the random number to create a data matrix

29. The method of claim 28, wherein the data matrix comprises a 16×16 random binary data matrix of ones and zeroes.

30. The method of claim 28, wherein the location comprises a biological location or a non-biological location.

31. The method of claim 28, wherein the random number is a 256 bit random number.

32. A method executed by a computing device to encrypt large documents rapidly with elliptic curve cryptography (ECC), the method comprising:
calculating a temporary public key for a temporary private key Pⁱ by using a first equation of Pⁱ(Xⁱ,Yⁱ)=r₂ⁱG₀, wherein G₀ is a generator point for an elliptic curve;
imbedding hexadecimal strings into an X value of the first equation for the public key by using a second equation of Jⁱ=Xⁱ−sᵢ;
replacing each sᵢ with Jⁱ;
constructing a temporary private key r₁;
computing a public key and an additional point using a third equation of P₁=r₁ G₀ and a fourth equation of P₂=r₁P, wherein P comprises a user's public key corresponding to a biocode, and wherein the biocode comprises the user's unknown and unknowable private key; and
utilizing a modular point addition to create and hide a database of points used to imbed an original string such that for each i, a fifth equation of Pⁱ=Pⁱ(Xⁱ,Yⁱ)+P₂ is used, wherein all Pⁱ and all Jⁱ are added to the database.

33. The method of claim 32, further comprising:
scanning a data matrix at a location external to the computing device to compute a private key k; and
engaging in a decryption process to recover imbed points by using a sixth equation of Pⁱ(Xⁱ,Yⁱ)+P₂−kP₁, wherein P=k G₀.

34. The method of claim 33, further comprising:
recovering original 32 byte plaintext segments from Xⁱ values of the imbed points by a seventh equation of sᵢ=Xⁱ−Jⁱ.

35. The method of claim 32, wherein the method for the encryption of the large documents rapidly with the ECC utilizes a secp256k1 version of ECC.

36. The method of claim 32, wherein the Pⁱ is created in a volatile memory of the computing device.
